(19) United States
(12) Patent Application Publication
(10) Pub. No.: US 2022/0222614 A1
(43) Pub. Date: Jul. 14, 2022

(54) NETWORK-BASED AUTOMATIC INVENTORY CONTROL AND PURCHASING SYSTEM FOR INDIRECT MATERIALS USING INTERACTIVE ELECTRONIC SHELF LABELS

(71) Applicant: SupplyPro, Inc., San Diego, CA (US)

(72) Inventor: Michael Reynolds, San Diego, CA (US)

(21) Appl. No.: 17/558,473

(22) Filed: Dec. 21, 2021

Related U.S. Application Data
(60) Provisional application No. 63/128,566, filed on Dec. 21, 2020.

(51) Int. Cl. G06Q 10/08; G09F 3/02

(52) U.S. Cl. CPC G06Q 10/087; G09F 2003/0219; G09F 3/02

(57) ABSTRACT

A computer-implemented system for analyzing and replenishing inventories of items at a plurality of customer sites at which electronic inventory tracking devices are deployed. A system platform is configured to receive, from the electronic inventory tracking devices, indications of inventory changes in the inventory levels of the items at the locations. The inventory levels of the items at the locations are evaluated determine whether inventories of the items are required to be replenished. This evaluation involves evaluating the availability of substitutes for the item at other locations as well as the availability of item alternatives and the determination of an aggregate need for the item among multiple locations. Overall prices including distribution costs are determined for various packaging permutations of the item capable of fulfilling the aggregate need. Purchase orders corresponding to a selected one or more of the packaging permutations are then generated for issuance to vendors.

### CROSS-REFERENCE TO RELATED APPLICATIONS

This application claims the benefit of priority under 35 U.S.C. § 119(e) of U.S. Provisional Patent Application No. 63/128,566, entitled NETWORK-BASED AUTOMATIC INVENTORY CONTROL AND PURCHASING SYSTEM FOR INDIRECT MATERIALS USING INTERACTIVE ELECTRONIC SHELF LABELS, filed Dec. 21, 2020, the content of which is incorporated herein by reference in its entirety for all purposes.

### FIELD

This application relates to inventory control systems and, more particularly, to automated inventory control and product replenishment systems.

### BACKGROUND

Materials purchased in bulk quantities are used in a wide variety of manufacturing and assembly processes. The materials procured for such manufacturing and assembly processes may be broadly categorized as direct materials and indirect materials. Direct materials are consumed against work orders and manufacturing loads and are highly planned. For example, a manufacturer planning to produce 6,000 sets of brake shoes in a given day may know, for example, that this would require 40 tons of aluminum. The ordering and supply of aluminum, one of the primary direct materials consumed in manufacturing the brake shoes, would be managed and tracked very precisely. For example, trucks or train cars delivering JIT (just in time) direct materials such as aluminum would be scheduled to show up at the manufacturer's factory premise just as such direct materials are needed. Typically, an enterprise resource planning (ERP) system would manage every aspect of this process. However, such ERP systems are not set up to track or manage the indirect materials consumed or used ancillary to the direct manufacturing process. Such indirect materials could include, for example, safety glasses, vests, gloves, respirators, etc. Procurement of such indirect items is generally completely outsourced to an industrial distributor.

The largest distributors can only justify utilizing automated inventory control to track indirect materials for the top end of their customer base. Generally, only a small percentage of a distributor's customers have their indirect materials managed through automated vending. The remainder is managed manually. Traditional automated vending costs about $400-$500 per SKU and a machine can handle approximately 100 SKU's on average. Many of the large distributors require a minimum of tens of thousands of dollars in annual spend to justify a single automated vending machine to facilitate inventory control. The distributor typically subsidizes the cost of the vending solution from margin on the commodity purchases of indirect materials. The cumulative spend by most of a distributor's customers often doesn't justify a single machine.

When automated vending is not employed, inventory control of indirect materials is generally performed manually. Even the largest customers of distributors tend to use manual labor and processes to manage a large portion of their inventory of indirect materials. Even entities with sophisticated ERP systems rarely connect such systems to monitor inventory consumption at the user level.

Historically, inventory control was handled manually by personnel performing physical cycle counts of the inventory. Such personnel may walk up and down the aisles of a warehouse and physically count and/or scan products. The personnel are unaware of how many of a given item are being used, scheduled to be used, or actually consumed by end-users. Rather, their role is limited to physically counting the items of indirect materials on a warehouse shelf at any given time. This does not track who used what or provide any cost control data; it simply keeps track of inventory levels, not usage.

For small manufacturers or other small customers of a distributor, a representative of the distributor will typically visit the manufacturing facility around once per week. This representative generally performs a variety of roles (e.g., route driver, sales person and put-away/stocker person, etc.). The representative will either have an idea of what the customer typically buys and stock their truck accordingly, or will simply have all their normally stocked and available products. The representative will do an assessment of what the customer might need, go out to the truck and pull inventory, stock it, and prepare a manual invoice or record purchases for billing.

In the case of larger manufacturers, purchasing personnel are often required to utilize large ERP systems for all of their purchasing. Since in large industrial locations the purchases of indirect materials may be only 4%-5% of overall purchasing activity, large ERP are not geared to procuring indirect materials and configuring them to potentially do so is very expensive and time consuming. Current ERP systems are exceedingly complicated at least in part because they are enormously feature rich, which is driven by their focus on expensive and strategically critical direct materials. They are designed to control much larger purchases than those associated with procurement of indirect materials, as well as to support longer-term flows and more components of the supply chain.

Notwithstanding these advantages of ERP systems, manufacturing production lines cannot be run without a reliable supply of indirect materials and the line will typically be required to stop if the necessary indirect material are unavailable. Despite this, indirect materials are often being ignored or mismanaged. These materials are typically handled via “free stock” meaning any employee can walk into a warehouse, a crib, or a store room before they walk onto the factory floor for their shift and self-select materials. In many cases, safety materials, are on racks right outside the break room at the entry to the manufacturing floor. Gloves, goggles, etc., are in a bin and employees just grab what they need. It's not only safety materials and PPE, MRO, repair parts and the like are often managed the same way.

This type of behavior creates difficulties when ERP systems are utilized for procurement of indirect materials. In particular, such systems will be unaware of current stocking levels or consumption rates of the indirect materials being utilized, nor will there be an awareness of which users are using which products and whether or not such usage is correct and/or authorized. Although ERP may be set up to purchase products from a pre-approved list of vendors associated with large commodity contracts, indirect materials are typically sourced outside of such contracts and are not tracked by such systems. As a consequence, it is generally necessary to manually inventory or otherwise count quantities of indirect materials available in a factory environment before utilizing an ERP system to replenish such materials.

### SUMMARY

A network-based platform configured to facilitate automatic control of the inventory of indirect materials used during industrial production is disclosed herein. The platform of the present disclosure is configured to track the use of indirect materials by client manufacturing entities, utilize artificial intelligence techniques to predict demand for such indirect materials based upon historical usage data and other parameters, and facilitate procurement of a supply of such materials or functionally equivalent substitutes from a network of suppliers. The platform operates in conjunction with electronic tracking hardware or scanning systems deployed at manufacturer facilities to enable real-time tracking of the consumption and replenishment of indirect materials. The value exchange facilitated by the platform is based on efficiently connecting indirect material producers with the industrial customers who rely on those items. The platform ecosystem is fueled by intelligent inventory/usage data to drive behaviors and create a positive network effect between the producer and user.

In one particular aspect the disclosure relates to a network-based platform for facilitating monitoring and replenishment of inventories of indirect material items utilized by client manufacturers based upon item usage information provided by electronic tracking systems which are deployed at the client manufacturers and are in communication with the network-based platform over a network. The platform includes a network interface for establishing network connections with the client manufacturers and a plurality of suppliers of indirect materials. A database stores the current indirect material inventory information for each of the client manufacturers as well as historical usage data. An inventory processing module receives the current indirect material inventory information provided by the take and return systems wherein at least some of the take and return systems include user interfaces through which item usage and return information is entered. An analytics module is configured to predict, based upon the current indirect material inventory information and the historical usage data, future consumption of the indirect materials by the client manufacturers. The inventory processing module is further configured to facilitate ordering, from the plurality of suppliers, quantities of indirect material items determined based at least in part upon the predicted future consumption of the indirect materials.

The disclosure also pertains to a computer-implemented system for analyzing and replenishing inventories of items used by a plurality of manufacturer customers operating at a plurality of customer sites where the items are supplied by a plurality of vendors. The system includes a network interface for communicating, over one or more networks, with servers associated with the plurality of vendors and with electronic inventory tracking devices deployed within customer warehouses at the plurality of customer sites. At least a subset of the electronic tracking devices are implemented by one or more of: electronic shelf labels, handheld electronic devices, smart drawers, coil devices, smart cabinets and scanner systems. The system further includes a database containing inventory levels of the items, a memory for storing instructions, and one or more processors. The one or more processors are configured to execute the instructions for receiving, from the electronic inventory tracking devices, indications of inventory changes in the inventory levels of the items at warehouse locations within customer warehouses at the plurality of customer sites. The instructions are also for updating the inventory levels of the items within the database based upon the indications of inventory changes and for evaluating, in response to the indications of inventory changes, the inventory levels of the items at the warehouse locations to determine whether inventories of the items are required to be replenished. The instructions for evaluating further include instructions for calculating safety stocks of the items at the warehouse locations so as to accommodate for fluctuations in usage of the items at the warehouse locations and for calculating, based upon the safety stocks, minimum inventory levels for the items at the warehouse locations. The instructions for evaluating further including instructions for (i) comparing current inventory levels of the items at the warehouse locations to respective ones of the minimum inventory levels, (ii) evaluating, for depleted warehouse locations at which the current inventory level for an item is less than the minimum inventory level for the item, other of the current inventory levels of the item at a first set of warehouse locations included in the warehouse locations, (iii) identifying, for the depleted warehouse locations, any substitute items for the item at a second set of warehouse locations included in the warehouse locations. The instructions further include instructions for performing a predictive speculative need calculation to determine, for ones of the manufacturer customers utilizing other warehouse locations at which the current inventory level for the item exceeds the minimum inventory level for the item, whether speculative purchases of the item for speculative warehouse locations included among the other warehouse locations would yield savings for the ones of the manufacturer customers. The instructions executed by the processor are also for determining, based upon results of the instructions for comparing, the instructions for evaluating, the instructions for identifying, and the instructions for performing a predictive speculative need calculation that an aggregate need exists to place an order to replenish stock of the item at the depleted warehouse locations and at one or more of the other warehouse locations. The instructions executed by the processor further include instructions for identifying one or more item alternatives to the item that can be purchased to fulfill the aggregate need, selecting a set of the vendors capable of providing the item and the one or more item alternatives, and compiling packaging type information relating to different packaged quantities of the item and the one or more item alternatives that can be purchased from the set of vendors. Based upon the packaging type information, execution of the instructions generates purchase permutations of purchases of the item and the one or more item alternatives from the set of vendors that could be made to fulfill the aggregate need. The instructions are also for calculating overall prices for the purchase permutations wherein each overall price is determined based upon a number of units required within a corresponding vendor service area and per unit prices for the item and the one or more item alternatives associated with ones of the set of vendors. Based upon the overall prices for the permutations, the instructions may be executed to select ones of the purchase permutations in order to fulfill the aggregate need and to generate purchase orders for the selected purchase permutations on behalf of the customer manufacturers associated with the depleted warehouse locations and the speculative warehouse locations, the purchase orders being for quantities of the item and the item alternatives.

The first set of warehouse locations and the second set of warehouse locations may be included within ones of the customer warehouses located at a first customer site of the plurality of customer sites. In this case the instructions may further include instructions for identifying a second customer site having one or more additional warehouses having warehouse locations requiring replenishment of the item and for including an amount of stock of the item required to be replenished at the second customer within the aggregate need for the item.

The disclosure is further directed to a computer-implemented system for analyzing and replenishing inventories of items used by a plurality of manufacturer customers operating at a plurality of customer sites, the items being supplied by a plurality of vendors. The system includes a network interface for communicating, over one or more networks, with servers associated with the plurality of vendors and with electronic inventory tracking devices deployed within customer warehouses at the plurality of customer sites. The system further includes a database containing inventory levels of the items, a memory for storing instructions, and one or more processors configured to execute the instructions. The instructions include instructions for receiving, from the electronic inventory tracking devices, indications of inventory changes in the inventory levels of the items at warehouse locations within customer warehouses and updating the inventory levels of the items within the database based upon the indications of inventory changes. The instructions further include instructions for evaluating, in response to the indications of inventory changes, the inventory levels of the items at the locations to determine whether inventories of the items are required to be replenished and to determine an aggregate need for the item. The instructions further including calculating overall prices for purchase permutations of the item and one or more item alternatives where each overall price is determined based upon a number of units required within a corresponding area being serviced and per unit prices for the item and the one or more item alternatives. The instructions further including instructions for selecting, based upon the overall prices for the permutations, one or more of the purchase permutations in order to fulfill the aggregate need and for generating one or more purchase orders for the one or more selected purchase permutations.

In another aspect the disclosure relates to a computer-implemented system for analyzing and replenishing inventories of items used by a plurality of manufacturer customers operating at a plurality of customer sites, the items being supplied by a plurality of vendors. The system includes a network interface for communicating, over one or more networks, with servers associated with the plurality of vendors and with electronic inventory tracking devices deployed at locations at the plurality of customer sites. The system further includes a database containing inventory levels of the items, a memory for storing instructions, and one or more processors configured to execute the instructions. The instructions includes instructions for receiving, from the electronic inventory tracking devices, indications of inventory changes in the inventory levels of the items at the locations within the plurality of customer sites. The instructions further include instructions for updating the inventory levels of the items within the database based upon the indications of inventory changes and for evaluating, in response to the indications of inventory changes, the inventory levels of the items at the locations to determine whether inventories of the items are required to be replenished. The instructions for evaluating further include instructions for (i) comparing current inventory levels of the items at the locations to respective ones of minimum inventory levels and identifying, for depleted locations at which the current inventory level for an item is less than the minimum inventory level for the item, any substitute items for the item at other locations, and (ii) determining, based upon results of the instructions for comparing and the instructions for identifying, that an aggregate need exists to place an order to replenish stock of the item at the depleted locations. The instructions further include instructions for selecting a set of the vendors capable of providing the item and for compiling packaging type information relating to different packaged quantities of the item. When executed the instructions generate, based upon the packaging type information, purchase permutations of purchases of the item from the set of vendors that could be made to fulfill the aggregate need and calculate overall prices for the purchase permutations. The instructions further include instructions for selecting, based upon the overall prices for the permutations, ones of the purchase permutations in order to fulfill the aggregate need and for generating purchase orders for the selected purchase permutations on behalf of the customer manufacturers associated with the depleted locations.

### BRIEF DESCRIPTION OF THE DRAWINGS

For a better understanding of the nature and objects of various embodiments of the invention, reference should be made to the following detailed description taken in conjunction with the accompanying drawings, wherein:

FIG. 1 provides a high-level overview of principal components of a network-based system for efficiently connecting suppliers of indirect material with the industrial customers who rely on those items.

FIG. 2 illustrates an implementation of an inventory tracking device in the form of a cabinet having a plurality of drawers adapted to store items.

FIG. 3 illustrates a drawer removed from the cabinet of FIG. 2.

FIG. 4 illustrates an electronic shelf tag configured as an implementation of an inventory tracking device.

FIG. 5 illustrates an alternate implementation of an electronic shelf tag configured as an implementation of an inventory tracking device.

FIG. 6 illustrates an exemplary deployment of shelf tags within a factory or other manufacturing facility of a client manufacturer or other customer.

FIG. 7 illustrates exemplary elements of a bar code scanning implementation of an inventory tracking device.

FIGS. 8-20 are a series of flowcharts illustrating a computer-implemented process for automatic inventory tracking and procurement in accordance with the disclosure.

FIG. 21 illustrates a normal distribution along with associated Z scores and T scores.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

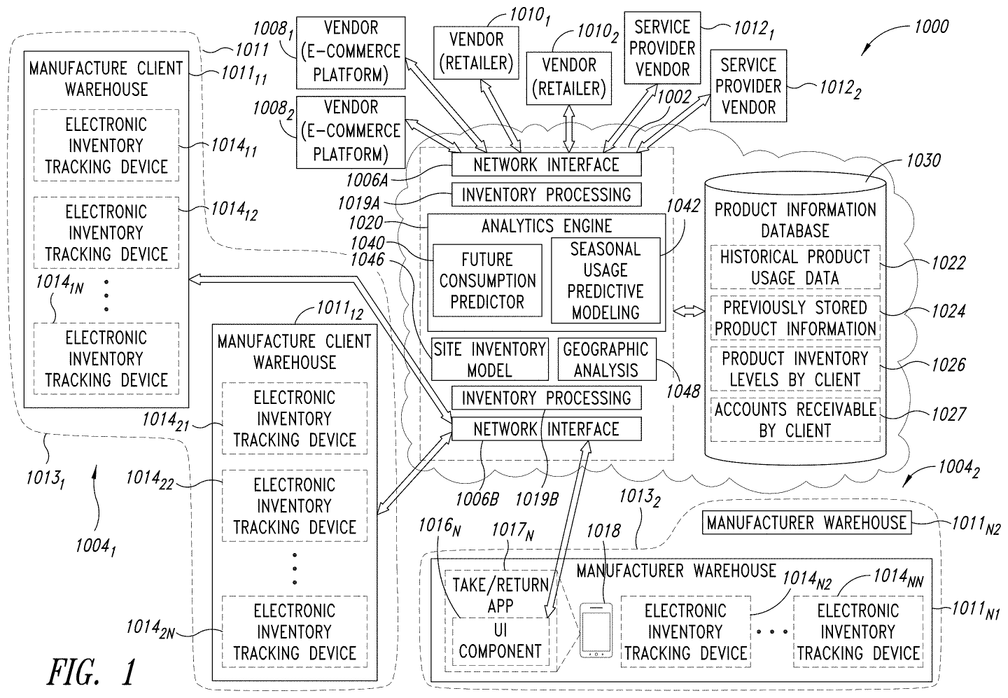

Attention is now directed to FIG. 1, which provides a high-level overview of principal components of a network-based system 1000 for efficiently connecting suppliers of indirect material with the industrial customers who rely on those items. As shown, the system 1000 includes an AI-based transactional platform 1002 configured to facilitate supply transactions between manufacturer customers 1004 consuming indirect materials and various vendors suppliers of such materials including vendors operating e-commerce platforms 1008₁, 1008₂, vendors operating as retailers 1008₃, 1008₄, and other service provider vendors 1012. As is discussed below, the platform 1002 includes an inventory processing module 1019 which receives information tracking the use of indirect materials by the manufacturer customers 1004. An analytics engine 1020 utilizes artificial intelligence to predict demand for such indirect materials based upon the tracked usage data, historical usage data, and other parameters. Based upon this predicted demand, the inventory processing module 1019 facilitates procurement of a supply of such materials or functionally equivalent substitutes from a network of suppliers 1008. In contrast to legacy ERP systems, the system 1000 is fueled by intelligent inventory/usage data to drive behaviors and create a positive network effect between producers and suppliers of indirect materials and users of such materials.

In the embodiment of FIG. 1, each manufacturer customer 1004 may utilize one or more warehouses 1011 on a given customer site 1013. Each customer site 1017 may also include, for example, facilities for carrying out manufacturing operations (not shown). Each warehouse 1011, which may or may not be co-located with a manufacturing facility, includes a plurality of warehouse locations at which are disposed parts or other products used during manufacturing operations. The inventory of parts or products at each warehouse location may be monitored by an electronic inventory tracking device 1014 in communication with the platform 1002 via one or more wired or wireless networks (not shown). Each inventory tracking device 1014 facilitates tracking, or otherwise monitoring inventory, of indirect materials used during manufacturing or production operations performed by an associated manufacturer client 1004. As is discussed below, each inventory tracking device 1014 may be implemented in a number of different ways including, for example, using interactive electronic shelf labels or tags, automated material vending apparatus, a bar code scanning system, handheld electronic devices, smart drawers, coil devices, and smart cabinets. Alternatively, in certain implementations an enterprise Web application may be used for inventory tracking purposes in lieu of deploying electronic inventory tracking devices at locations within the warehouses 1011. In one embodiment each inventory tracking device 1014 includes a user interface including take/return buttons through which users or consumers of indirect materials may indicate use or taking of an item of indirect materials from a storage location and, when appropriate, return of the item of indirect materials to the storage location. In one particular embodiment the inventory tracking device is implemented as a take/return app 1017 executing on a mobile wireless device 1018 such as, for example, a wireless phone. The app 1017 may include a UI component 1016 for generating a user interface through which product take and return information may be entered by a user and, optionally, through which current inventory levels may be displayed.

Referring to FIG. 1, the platform 1002 includes a number of functional modules configured to track actual usage of indirect materials by client manufacturers 1004, use artificial intelligence to predict future usage, and automatically coordinate lowest-cost purchases of materials from suppliers 1008. As shown, the platform 1002 includes a network interface 1006 configured to manage communication with client manufacturers 1004 and suppliers 1008 over one or more wired or wireless networks (not shown). As noted above, the inventory processing module 1019 is configured to manage indirect material inventory information and facilitate transactions involving indirect materials between client manufacturers 1004 and suppliers 1008. The analytics engine 1020 includes a future consumption predictor 1040 configured to predict consumption of indirect materials in the manner described hereinafter. A seasonal usage predictive modeling module 1042 enables refinement of predicted consumption by taking into account historical seasonal usage patterns. The platform 1002 further includes a site inventory model 1046 and a geographic analysis module 1048. The platform 1002 is in communication with a product information database 1030 which includes historical product usage data 1022, product catalogs 1024, and information relating to product inventory levels by client manufacturer 1026.

In one embodiment the AI-based transactional platform 1002 is implemented as a cloud-based platform. As is known, cloud computing may be characterized as a model for facilitating on-demand network access to a shared pool of configurable computing resources (e.g., networks, servers, storage, applications, nodes and services) that can be rapidly provisioned and released with minimal management effort or service provider interaction. Cloud systems tend to automatically control resource use by utilizing some form of metering capability with respect to, for example, storage, processing, bandwidth, and active user accounts. Various cloud service models are possible, including cloud software as a service (SaaS), cloud platform as a service (PaaS), cloud infrastructure as a service (IaaS) and user or networked participant deployed decentralized nodes, compromising a decentralized network running the software In one embodiment the platform 1002 operates through an Amazon® Web Service Cloud. Of course, in other embodiments some or all of the platform 1002 may be implemented using other cloud environments such as, for example, a Microsoft® Azure cloud or another third party cloud. In other embodiments the AI-based transactional platform 1002 may be implemented by using on premise servers and other infrastructure rather than by using cloud-based services. Alternatively, hybrid implementations of the AI-based transactional platform 1002 including a combination of on premise and cloud-based resources are possible, including the provision of the system using a decentralized network of independent nodes.

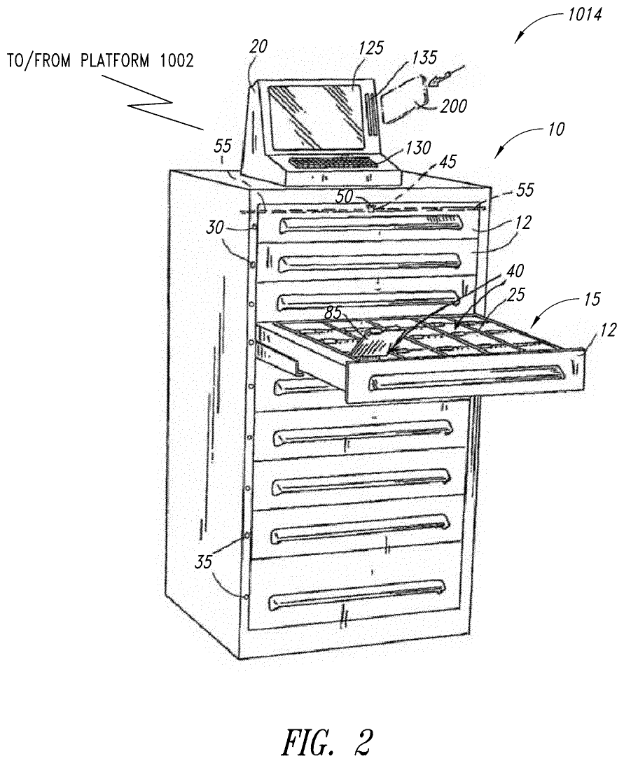

FIG. 2 illustrates an implementation of an inventory tracking device 1014 in the form of a cabinet 10 having a plurality of drawers 12 adapted to store items and fitted with a kit 15. The kit 15 includes a control center 20, a plurality of panels 25, and a plurality of indicators 30. The indicators 30 are generally light emitting diodes (LED) that illuminate to aid the user in finding the desired item. For example, the cabinet 10 of FIG. 2 includes a plurality of drawer LEDs 35 positioned vertically down the front of the cabinet 10 adjacent the drawers 12. One LED 35 is positioned adjacent each drawer 12. When a user requests an item, the LED 35 that corresponds to the drawer 12 that contains the item is illuminated to quickly guide the user.

The term “item” as used herein includes any physical thing that may be used by a user (e.g., a factory worker) or incorporated into a product being manufactured. Items include but are not limited to product parts, tools, chemicals, substances, food ingredients, consumables, personal protective equipment such as gloves, masks, safety goggles, etc.

In the illustrated embodiment of FIG. 2, the cabinet 10 includes nine drawers 12, with more or less drawers 12 being possible. In addition, each drawer 12 is subdivided into a plurality of compartments 40. For example, the drawer 12 shown in the open position in FIG. 2 is subdivided into twenty compartments 40. Other constructions may employ a drawer 12 or drawers 12 that are not subdivided, but instead provide one large compartment 40. Still other constructions may employ more or less than twenty compartments 40. The walls subdividing the drawers are often movable to allow the user to configure the compartments 40 as necessary for a particular use.

Each drawer 12 slides into and out of the cabinet 10 to provide a user with access to the parts, tools, or other items stored within the drawers 12. In some cabinets 10, a lock mechanism 45 allows the user to lock all of the drawers 12, thereby preventing unwanted removal of the cabinet's contents. Many lock mechanisms 45 are available that secure the drawers 12 of cabinets 10. FIG. 2 illustrates a lock mechanism 45 that includes a key 50 that moves two bars 55 into engagement with a mechanism that prevents the drawers 12 from opening. A still simpler device includes an L-shaped piece (not shown) connected to the cabinet at a hinge. The L-shaped piece covers a portion of the drawers when in the locked position to prevent their opening. Other constructions employ a solenoid-actuated lock that locks all of the drawers. The solenoid-actuated lock may include a single solenoid capable of locking or unlocking all of the drawers or may include multiple solenoids, each capable of locking or unlocking one or more of the drawers.

The cabinet 10 illustrated is stationary; that is, it is placed directly on the floor or onto another cabinet within a factory, shop, or storage area. Other constructions include cabinets 10 placed on castors or wheels to provide mobile sources of items. In the case of a mobile cabinet, a mobile power supply may be included with the kit 15 to allow the cabinet to be positioned remote from a power supply.

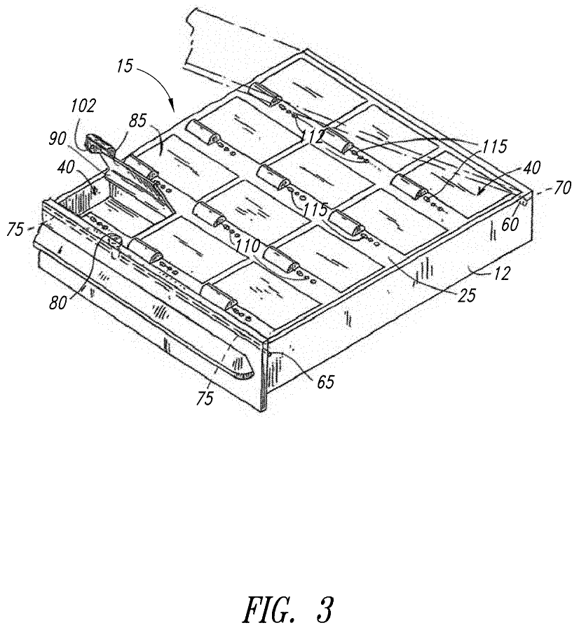

Turning to FIG. 3, a drawer 12 is illustrated removed from the cabinet 10 of FIG. 2. The drawer 12 includes one of the panels 25 of the kit 15 connected to the drawer 12 by a hinge 60 at the rear of the panel 25 and a lock-rod 65 at the front. The hinge 60 includes a rod 70 that extends the full width of the drawer 12 and engages both the drawer 12 and the panel 25. The rod 70 attaches in a manner that allows the panel 25 to pivot about the rod 70. Other constructions use two or more smaller hinges that attach to both the rear of the drawer 12 and the panel 25. In still other constructions, the panel 25 may include two pins sticking out a back edge of the panel 25 and into holes in the rear wall of the drawer 12. The holes are sized such that the pins need not be positioned in the holes only perpendicularly to the holes. The pins can angle back and forth in the holes and permit the panel 25 to be opened and closed relative to the drawer 12. In this way, the pin/hole combination serves as a “hinge” at the back of the drawer.

Again referring to FIG. 3, the lock-rod 65 includes two rods 75 that connect to a key-mechanism 80 or other security device that is actuatable by only certain users (e.g., users with the key). When rotated into the locked position, the rods 75, which slidably connect to the panel 25, extend into the side of the drawer 12. Thus, the rods 75 prevent the lifting or removal of the panel 25 without disassembling the hinge 60 or causing damage. When the key 80 is rotated to the unlocked position, the rods 75 retract and disengage the drawer 12, thereby allowing the panel 25 to be opened by pivoting it about the hinge 60.

In another construction, an electronic locking device is employed. One or more solenoids (not shown) engage the panel 25 and the drawer 12 in the deenergized state. A user inputs a code into the control center 20 (FIG. 2) or other controller to indicate sufficient rights to gain access to the drawer 12. The solenoid energizes to disengage from the drawer 12 and allow access. While the lock mechanism has been described as using a code, many other methods of determining a user's identity (e.g., biometrics, such as fingerprint identification, etc.) are contemplated.

The openable panel 25 allows for quick restocking, inventory, or manual override (e.g., in the event of power failure), etc., of the compartments 40 within the drawer 12. A user with sufficient rights or access privileges opens the panel 25 to gain access to all of the compartments 40. The user can easily add or remove items from some or all of the compartments 40, as desired.

Still referring to FIG. 3, a plurality of covers 85 attach to the panel 25, or are formed as part of the panel 25, in a pattern that matches the compartment arrangement within the drawer 12. Because many different drawer patterns are available in existing cabinets 10, many different panels 25 are necessary and contemplated by the invention.

Also included with the kit 15 are take and return switches 110, 112, a compartment LED indicator 115, and a photodetector, mechanical switch, or other detector 120 for each compartment 40. The take and return switches 110, 112 aid the control center 20 in monitoring the quantity of items within each compartment 40. Each time a user actuates the take switch 110 (and subsequently opens the cover 85 associated with the compartment 40), the control center 20 records the removal of a single item from the open compartment 40 and communicates this removal to the platform 1002 via one or more wired or wireless networks, typically including the Internet. When a user actuates the return switch 112, the control center 20 registers an increase in the quantity of items within the compartment 40 and also communicates this increase in quantity to the platform 1002. Alternatively, each compartment 40 could contain only a single item, so that a user would not need to actuate take and return switches 110, 112. Instead, the control center 20 would record the removal of an item (and communicate such removal to platform 1002) whenever a cover 85 is opened.

In preferred constructions, the take and return switches 110, 112 signal the solenoid 100 to energize to open the desired compartment 40. In other constructions, the control center 20 signals the solenoid 100 to energize and open the compartment 40.

The take and return switches 110, 112 can be simple buttons or toggle switches. However, other constructions employ other devices to indicate when an item is removed or replaced. For example, one construction uses an electromagnetic or light curtain covering the opening. When the user removes or replaces a part, the curtain is broken and a signal is sent to the control center to register the removal or replacement of a part. Other constructions use magnetic detectors, or weight or pressure sensors to determine when an item or part is removed from the compartment 40. Still other constructions may employ embedded chip technology to detect the removal of a part. In one embodiment each part or an attached label contains a microchip (such as RFID), or other device or element, that can be detected by sensors near each compartment. The removal is detected by the sensors and registered. The photodetector 120 sends a signal to the control center 20 to indicate that the compartment cover 85 is open.

The compartment LED indicators 115 within the drawers 12 are positioned adjacent the various compartments 40. When a user successfully requests an item, the LED 115 adjacent the compartment 40 containing the item illuminates to quickly guide the user to that compartment. While not necessary for the security provided by the kit 15, the LEDs 115 facilitate improved worker productivity by reducing the time spent looking for a particular item.

Again referred to FIG. 2, the control center 20 includes a video display 125, a microprocessor, a memory device, a data storage device, and a network interface, all preferably housed within control center 20. Also included are a keyboard 130, and a card reader 135. In one embodiment the control center 20 runs a program that both regulates access to the components within the cabinet 10 and maintains an accurate inventory of the items within the cabinet 10. Furthermore, the program can monitor the rate of use of specific components, the length of time the items have been in a particular compartment 40, and the person or persons accessing the cabinet 10. Generally, the program is stored on the control center's data storage device for execution by the microprocessor and the memory device. In other embodiments the inventory of items within the cabinet 10 is maintained by one or more functional modules of the platform 1002 rather than by the control center 20. It should be understood that the control center 20 can be used to monitor various parameters concerning multiple cabinets 10, both proximate to and remote from the control center 20.

To access the cabinet 10, the user swipes a card 200 through the card reader 135 or inputs a user identification code and/or a password into the control center 20 via the keyboard 130. If the person has the proper rights, the video display 125 presents a user interface that facilitates access to the items within the cabinet 10. A graphical user interface (GUI) displays a list of items available or another representation that facilitates the proper item choice. For example, a factory may provide a cabinet 10 that contains all of the necessary replacement parts and special tools needed to disassemble, repair, or build a particular component such as an engine or pump. The GUI would present an assembly procedure including drawings or special tools needed. When the user indicates that a step requiring a special tool has been reached, the proper drawer 12 is indicated and the LED 115 indicating the proper compartment 40 illuminates. Thus, the cabinet 10 acts to assure that the proper tools and parts are used to assemble a product or sub-assembly.

In another example, the cabinet 10 acts as a spare parts repository for use in rebuilding old devices or sub-assemblies. As the rebuild progresses, assembly drawings are displayed in the GUI. A touch screen allows the user to touch the desired replacement part on the screen. The touch screen interfaces with the control center 20 to illuminate the proper drawer and compartment LED's 35, 115 to guide the user to the correct part. In some constructions, the control center 20 also signals the proper solenoid 100 to energize and open the compartment 40.

In another construction, embedded chip technology allows a user to waive a card or fob past a detector to gain access to the cabinet 15. In still other constructions, a biometric device determines user identity based on biological characteristics (e.g., face, fingerprints, hand geometry, handwriting, iris, retinal, vein, or voice, etc.) and replaces the card reader 135. The level of security desired determines the level of authentication required to gain access to the cabinet 10. Furthermore, a mouse or other input device may replace the keyboard 130 and/or touch screen 125. In one construction, a voice recognition module determines which item the user has requested.

The microprocessor of the control center 20 may be part of a computer including memory, input/output devices, and information storage devices. In other constructions, the microprocessor interfaces with a network to retrieve and store information, thereby centralizing control of several cabinets 10. In still other constructions, the control center 20 is a central computer or server and each cabinet 10 or group of cabinets 10 interface with it through a “dumb” terminal. The network interface may be wireless to facilitate easy movement of the cabinets 10 throughout a facility.

In use, the cabinet 10 controls access to the parts or items contained therein, tracks who is accessing the cabinet 10, and maintains an accurate inventory of the items. In addition, the cabinet 10 can be programmed to track project or job numbers, tool usage, or any other information desired, when items are accessed. This information can be used to aid in determining cost, waste, productivity, return of tools, or any other parameter desired.

To retrieve an item, a user first accesses the cabinet 10. Many methods have been described and are contemplated for this step. The specific method used is dependent on the level of security desired and the cost of implementing the system.

Once accessed, a GUI is displayed that facilitates the choice of the item within the cabinet 10. Again, multiple techniques of displaying items, from a simple list to a complicated assembly drawing, are contemplated. Once the user identifies the item, the choice is input into the microprocessor. This can be done by pointing to the item with a mouse, selecting the item from a list, touching a touch screen, or typing in an identifier such as a part name or number. In another construction, voice recognition technology allows the user to state the name or number of the desired part. In still other constructions, the user simply actuates the take switch 110 to indicate which part is desired.

Once input, the microprocessor or remote computer determines the drawer 12 in which the item is located and actuates an indicator 35. The indicator 35 illustrated is an LED. The user opens the appropriate drawer 12 to expose the compartments 40 within the drawer 12. A second indicator 115, again an LED in the illustrated construction, is illuminated near the compartment 40 containing the desired item. In addition to illuminating the two LEDs 35, 115, the computer or microprocessor in some constructions also actuates the appropriate solenoid 100 to unlock the cover 85 of the desired compartment 40. The user is now free to open the compartment 40 and remove the desired item in the desired quantity. In preferred constructions, the computer illuminates the LEDs 35, 115 to guide the user to the proper compartment and the user actuates the take or return switch 110, 112 to energize the solenoid 100 and open the compartment.

After removing the item, the user actuates the take switch 110 a number of times corresponding to the number of items taken. (As mentioned, if only one item is stored in each compartment 40, inventory can be monitored based on the opening of a cover 85 alone.) For example, if five items are removed, the take button 110 is depressed five times. Alternatively, the take button could be actuated once and the number of items taken could be entered into the computer. If, on the other hand, the user makes a mistake and depresses the take button 110 six times, the user simply needs to depress the return switch 112 once to correct the number taken to five. Thus, the control center 20 and/or the platform 1002 is able to maintain accurate control over the inventory within the cabinet 10. In other constructions, other sensors are employed to aid in inventory control. For example, one construction includes a pressure sensor or force cell disposed below the compartment. The sensor determines the weight of the objects within the compartment 40. The control center 20 or other computer uses the weight of the individual items and the weight within the compartment 40 to calculate the quantity of items within the compartment 40, and thus the quantity taken, which is then communicated to the platform 1002.

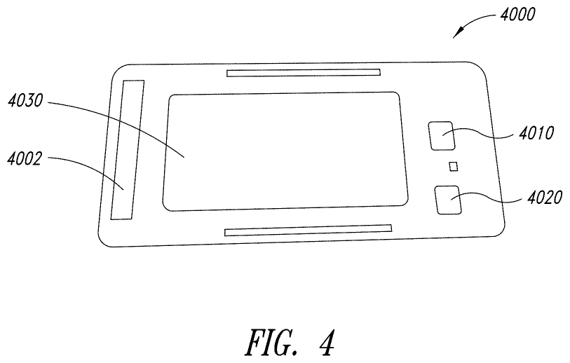

Turing now to FIG. 4, there is illustrated an electronic shelf tag 4000 configured as an implementation of the inventory tracking device 1014. The shelf tag 4000 includes a housing 4002, a take button 4010, a return button 4020 and a user interface display screen 4030. In one embodiment the display screen 4030 is a touch-sensitive electrophoretic display. The shelf tag 4000 may be positioned in, for example, a factory premises at the end of a shelf (not shown) proximate items of a particular type (e.g., a specific SKU).

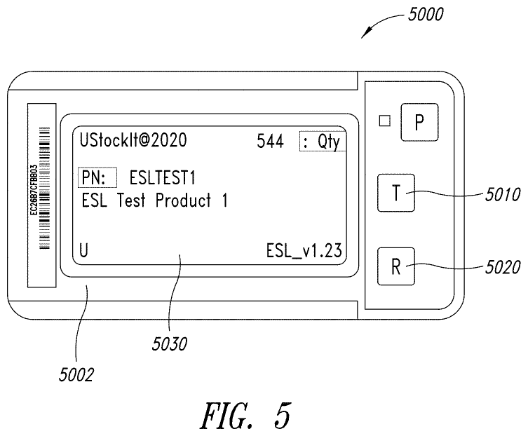

FIG. 5 illustrates an alternate implementation of an electronic shelf tag 5000 configured as an inventory tracking device 1014. The shelf tag 5000 includes a housing 5002, a take button 5010, a return button 5020 and a user interface display screen 5030. The shelf tag 5000 may be positioned in, for example, a factory premises at the end of a shelf (not shown) proximate items of a particular type (e.g., a specific SKU).

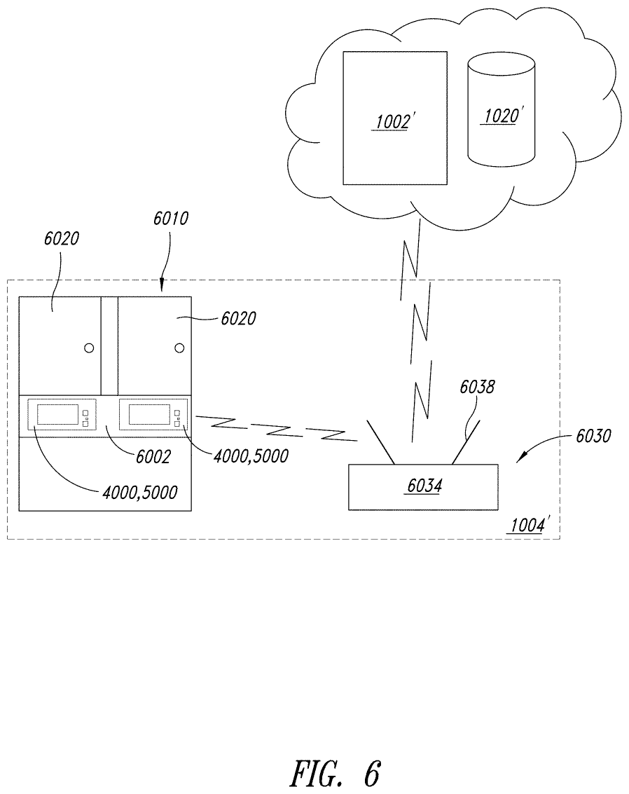

FIG. 6 illustrates an exemplary deployment of shelf tags 4000/5000 within a factory or other manufacturing facility of a client manufacturer 1004′. In the embodiment of FIG. 6 the shelf tags 4000/5000 are utilized to track an inventory of items taken from, and returned to, a cabinet 6010. In this embodiment the shelf tags may be located on a front surface 6002 of the cabinet 6010 proximate a cabinet door 6020, which provides access to an enclosed space in which are disposed units of the items being tracked. Each shelf tag 4000/5000 may be in communication with a wireless transceiver 6030 using a short range wireless protocol such as, for example, ZigBee, Bluetooth or Wi-Fi. The wireless transceiver 6030 may include transceiver electronics (not shown) disposed within a housing 6034 and one or more antennas 6038 connected to the transceiver electronics. The wireless transceiver 6030 may in turn be in communication with an implementation of the platform 1002′ through, for example, one or more wireless (e.g., cellular) networks and/or a wired Internet connection.

During operation, a user may open one of the doors 6020 of cabinet 6010 and remove one of the items stored within the cabinet 6010. After removing the item, the user actuates the take button 4010/5010 a number of times corresponding to the number of items taken. For example, if five items are removed, the take button 4010/5010 is depressed five times. Alternatively, the take button 4010/5010 could be actuated once and the number of items taken could be entered into the touch-sensitive display 4030. If, on the other hand, the user makes a mistake and depresses the take button 4010/5010 six times, the user simply needs to depress the return button 4020/5020 once to correct the number taken to five. Thus, the platform 1002 is able to maintain accurate control over the inventory within the cabinet 6010.

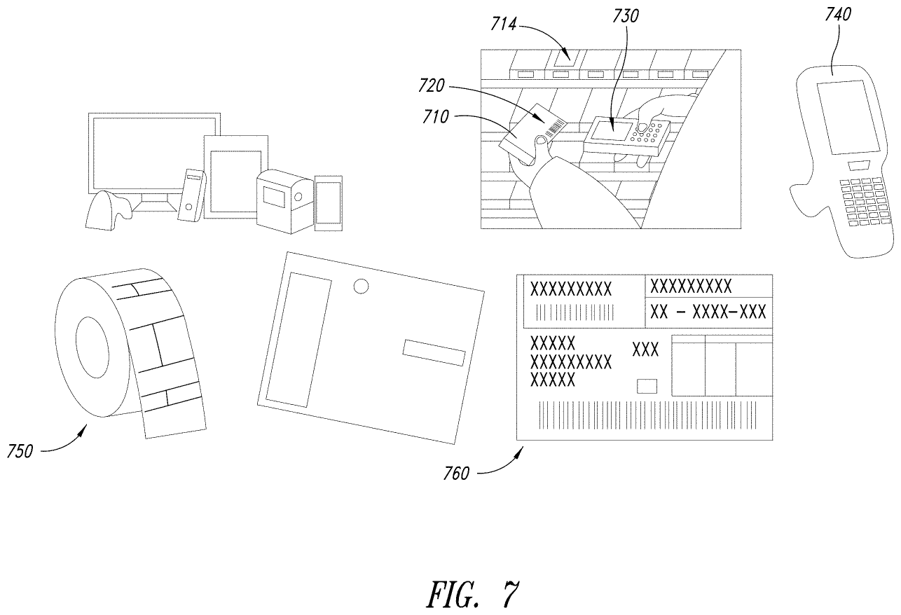

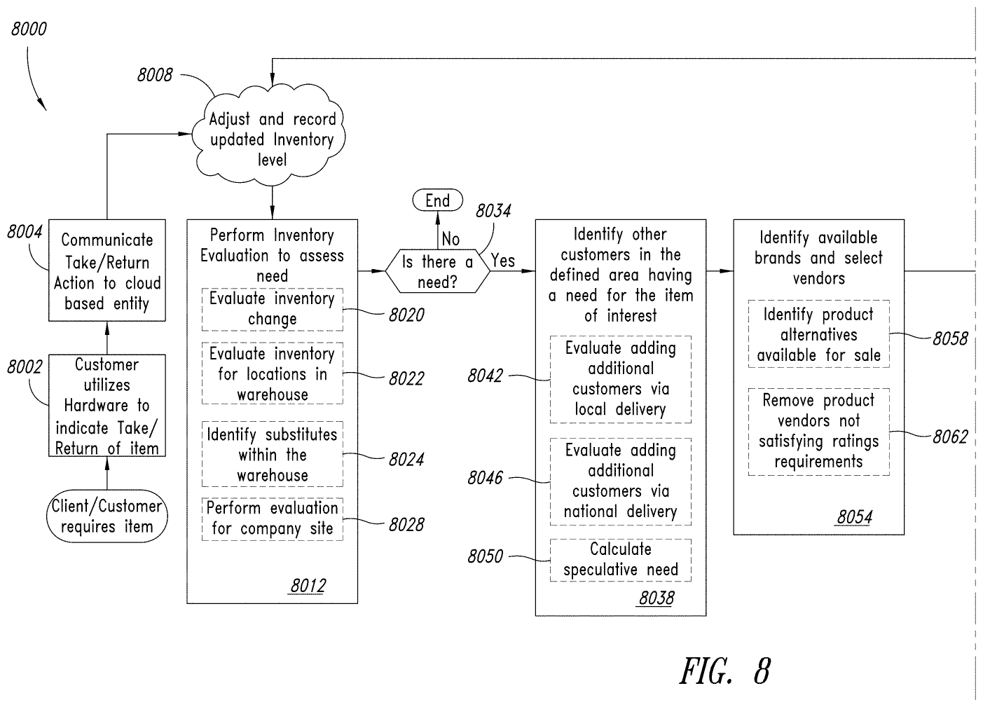

FIG. 7 illustrates exemplary elements of a bar code scanning implementation of the inventory tracking device 1014. In the bar code scanning implementation of FIG. 7, an item 710 to be taken from or returned to a storage location 714 may be labeled with a bar code 720, QR code, or other indicia capable of being scanned. The bar codes 720 of items 710 may be scanned by a mobile device 730 configured with a suitable scanning application or with a dedicated scanning device 740. Bar code labels to be affixed to items maintained in storage locations may be provided in a roll of bar code labels 750. In addition, as shown in the exemplary bar code label 760, information describing the item being stored may also be provided.

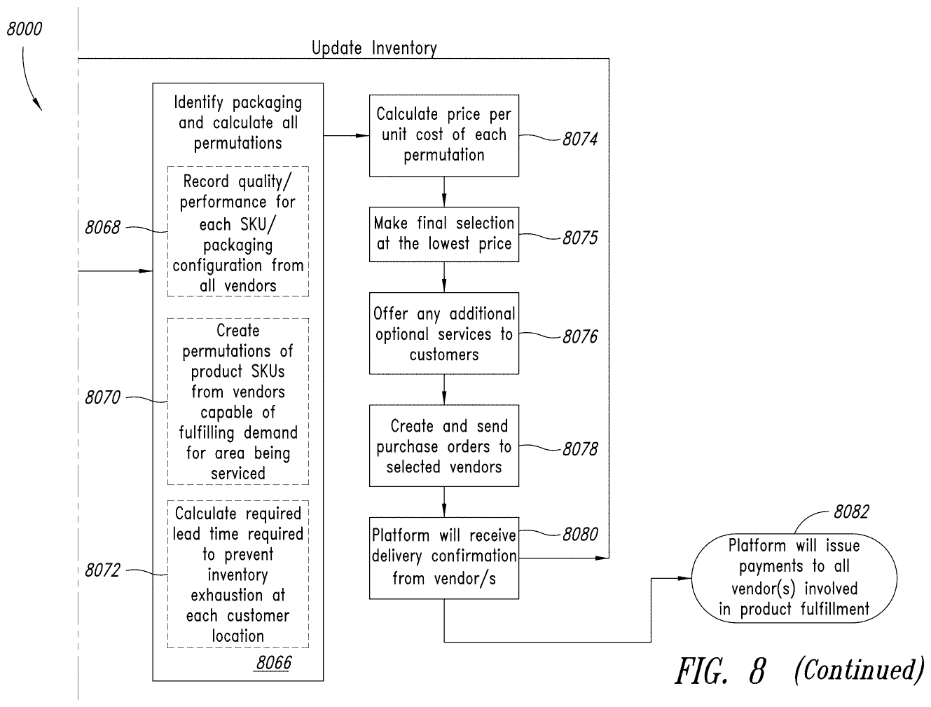

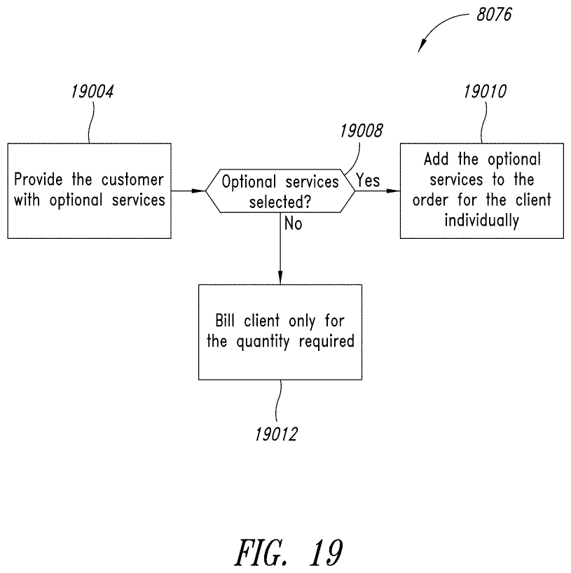

Attention is now directed FIGS. 8-20, which are a series of flowcharts illustrating a computer-implemented process for automatic inventory tracking and procurement in accordance with the disclosure. In the embodiment of FIGS. 8-20 this automated process is performed by at least the inventory processing module 1019 and analytics engine 1020 of the platform 1002 in cooperation with the inventory tracking devices 1014 deployed at the production facilities of the client manufacturers 1004. As is discussed below, in one embodiment the analytics engine 1020 of the platform 1002 uses artificial intelligence to develop predictive models of usage and consumption based upon historical product usage data in order to facilitate procurement decisions and otherwise optimize inventory control in response to current product inventory levels.

In one embodiment the platform 1002 pulls in data relating to the history of utilization of particular items or products used by client manufacturers 1004 and stores this as historical product usage data 1022 (FIG. 1). This product utilization data can be obtained in various ways such as, for example, being pulled from an enterprise resource planning (ERP) feed, a service provider 1012, or simply a file containing a listing of items which the client manufacturers 1004 are using or buying. This data could include the frequency and volumes of utilization of particular products over time. In certain cases the input data may include information concerning the manufacturers and part numbers of the products utilized. The analytics engine 1020 will examine the historical product usage data 1022 and determine which products it is has previously encountered (e.g., by matching part numbers and/or manufacturers of the products) to previously stored product information 1024, and will also determine which portions of the product utilization history relate to unknown products.

In warehouses today, inventory checks are performed by the warehouse employees on a random/scheduled basis. The employee will enter the warehouse/storeroom and manually count inventory in each location to see how much they currently have in stock. This data will provide the current level of inventory on site, and his will allow the employee to determine whether any change quantity has occurred. The employee will repeat this step for all warehouses/storerooms at a particular customer site.

In contrast, the system 1000 is supported by inventory tracking devices 1014 such as electronic shelf labels (ESLs) that will be used in the warehouse to track real-time changes in inventory. The ESL may be used by warehouse employees to indicate a “take” or a “return” of a product from a warehouse location. When a user returns a product to the shelf, they will press the “return” button on the ESL to indicate that an item has been added back to the warehouse location. The ESL will display the adjusted quantity and forward the message to the platform 1002 where the event will be recorded and set the updated current inventory. When a user takes a product from the shelf, they will press the “take” button to indicate that an item has been taken from the warehouse location. The ESL will display the adjusted quantity and forward the message to the platform 1002 where the event will be recorded and set the updated current inventory.

By employing these inventory tracking devices 1014 such as ESLs, embodiments of the present system enable the inventory check timeline to be reduced from once a week (scheduled basis) to an unscheduled and essentially real-time basis. The devices 1014 will generally be configured to transmit data to the platform 1002 as they are being used, thereby eliminating the need for a scheduled physical count of inventory.

Turning now to FIG. 8, there is illustrated a high-level process flow 8000 of one implementation of this process of automatic inventory tracking and procurement. As shown, a user at a client manufacturer 1004 requiring an item utilizes a deployment of an inventory tracking device 1014 to indicate take/return of the item (stage 8002). This take/return action is communicated to the platform 1002 (stage 8004), at which the inventory processing module 1019 adjusts and records an updated inventory level for the item (stage 8008).

Each time an item has been taken from or returned to an inventory tracking device 1014, the inventory processing module 1019 performs an inventory evaluation to assess need for inventory replenishment (stage 8012). If the inventory evaluation indicates that no additional items are required (stage 8014), then the process flow 8000 (stage 8016).

In warehouses today, employees that have completed the cycle count must now evaluate each location's current inventory in relation to a fixed inventory target (previously established minimum) value to determine if there has been any change. If the number of items is greater than the fixed inventory target, the warehouse employee will take no action regarding that location. If a decrease in the quantity of a location has been detected, the employee will need to evaluate whether the current quantity has declined further than fixed inventory target. If the current inventory is less than or equal to the fixed inventory target, the employee will indicate that the location needs inventory replenishment.

By using inventory tracking devices 1014 such as electronic shelf labels, the platform 1002 will be provided with real time data that is updated as soon as messages have been received from the devices 1014. In one embodiment the messages delivered contain the current quantity of an item after a take or return action has been performed on the device 1014. As messages are received, the inventory processing module 1019 will automatically update the current inventory for each warehouse location. This change in current inventory triggers an evaluation of the updated current inventory. As is discussed in further detail below, the results of the evaluation will be used to determine whether the location requires inventory replenishment or not.

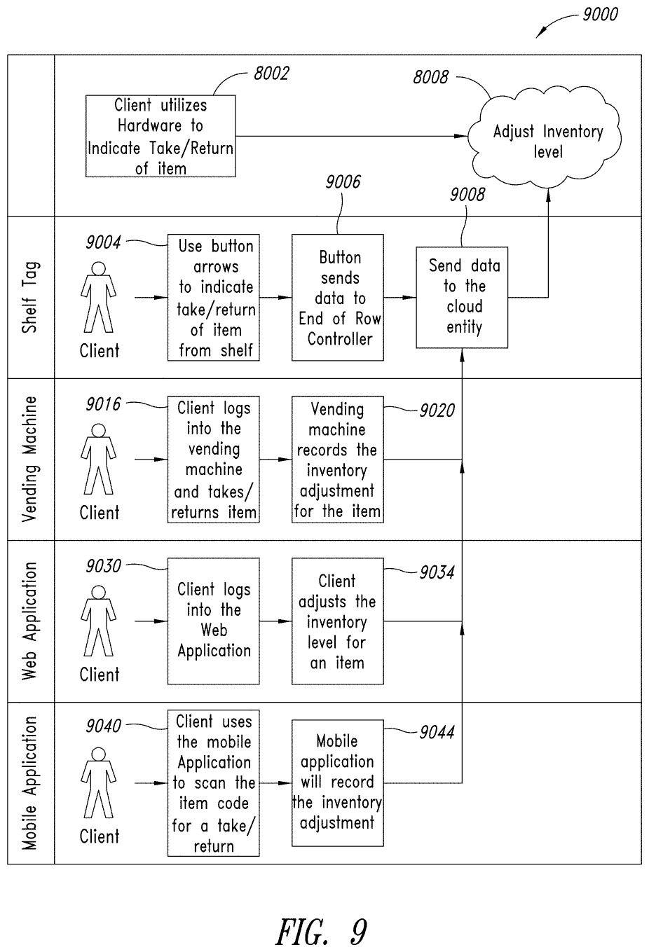

Turning now to FIG. 9, a high-level process flow 9000 illustrating the use of different implementations of the inventory tracking device 1014 to indicate take and/or return of items (stage 8002) is provided. As shown, when a shelf tag or the like is used as the inventory tracking device 1014, take and return buttons (which may be in the shape of up/down arrows) may be used to indicate the take/return of item(s) from a shelf on or near which the shelf tag is deployed (stage 9004). The shelf tag 4000 may then send the received take/return information provided by the user to an implementation of a wireless transceiver 6030 or other end-of-row controller (stage 9006). The transceiver 6030 then sends the acquired take/return data to the platform 1002 (stage 9008). In response, the inventory processing module 1019 adjusts an inventory level 1026 of the item with respect to the client manufacturer 1004 and/or the specific inventory tracking device 1014 (stage 8008).

When a vending machine is used as the inventory tracking device 1014 (see, e.g., the cabinet 10 of FIGS. 2 and 3), a user at client manufacturer 1004 logs into the vending machine and takes/returns an item (stage 9016). In some embodiments the vending machine may be configured to automatically detect the take/return of an item while in other embodiments the user may actuate take/return buttons when taking or returning an item. In either case the vending machine records the inventory adjustment for the item (stage 9020) and sends corresponding inventory data to the platform 1002 (stage 9008). In response, the inventory processing module 1019 adjusts an inventory level 1026 of the item with respect to the client manufacturer 1004 and/or the specific vending system (stage 8008).

In another implementation a Web application effectively functions as an inventory tracking device 1014. In this implementation a user at client manufacturer 1004 first logs into the Web application (stage 9030). The user then adjusts the inventory level for the item through the Web application (stage 9034) and sends corresponding inventory data to the platform 1002 (stage 9008). In response, the inventory processing module 1019 adjusts an inventory level 1026 of the item with respect to the client manufacturer 1004 (stage 8008).

In another implementation a mobile application executed by a mobile device effectively functions as an inventory tracking device 1014. In this implementation a user at client manufacturer 1004 uses the mobile application to cause the mobile device to scan the item code for a take/return (stage 9040). The mobile application will then record the inventory adjustment (stage 9044) and sends corresponding inventory data to the platform 1002 (stage 9008). In response, the inventory processing module 1019 adjusts an inventory level 1026 of the item with respect to the client manufacturer 1004 (stage 8008).

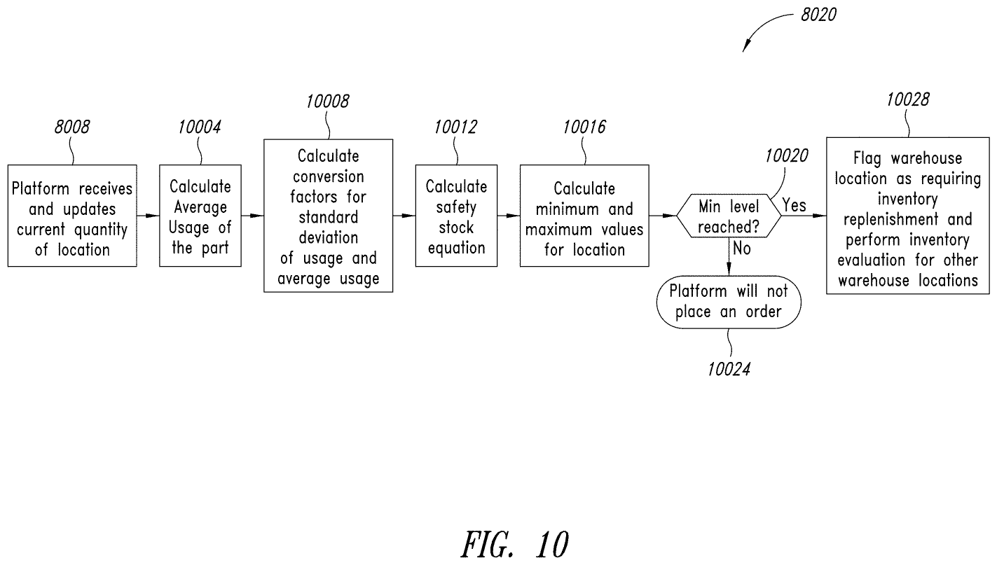

As shown in FIG. 8, the process of performing an evaluation of inventory to assess need for inventory replenishment (stage 8012) initially involves evaluating the item inventory at the applicable warehouse location subsequent to each take/return event (stage 8020). An exemplary process performed by the inventory processing module 1019 for implementing this inventory evaluation of stage 8020 is illustrated in FIG. 10.

Referring to FIG. 10, the inventory processing module 1019 initially determines the average usage of an item or part during a given period (stage 10004), typically 180 days (x). The period is broken into 30-day bins and the sum of the consumption of the part during that period is used as the value of the sample. Equation (1) illustrates one exemplary manner in which this average usage (x̅_{U}) may be determined:

$${\overline{x}}_{\overline{U}} = ⌈ \frac{Σ x}{n} ⌉ \qquad ( 1 )$$

where,

x=value of the sample (default to 1 month bins)

n=number of samples (default to 6 months)

Once the average usage has been calculated in accordance with Equation (1), the inventory processing module 1019 calculates a population standard deviation of usage. The population standard deviation of usage describes how widely samples are dispersed from the average value of a population of samples. Equation (2) illustrates one exemplary manner in which this standard deviation of usage (σ_{U}) may be determined:

$$\begin{matrix}{σ}_{U} = \sqrt{\frac{{Σ ( x - {\overline{x}}_{U} )}^{2}}{n}} \\ where \\ x = value of sample ( default to 1 month bins ) & ( 2 ) \\ {\overline{x}}_{U} = ⌈ \frac{Σ x}{n} ⌉ \\ n = number of samples ( default to 6 samples ) & ( equation . 1 )\end{matrix}$$

The inventory processing module 1019 then calculates conversion factors for standard deviation of usage and average usage are then calculated (stage 10008). In one embodiment the module 1019 first calculates the standard deviation of usage conversion factor, which is used to estimate the value of the variance in a part's data set of a desired bin length given a variance computed using some other bin length. This conversion factor can be used to estimate the variance that would be seen in a data set that had 90-day bins given calculated results with a 30-day bin. A minimum floor is set for this value of 1 in order to prevent under calculating variances. Equation (3) provides an example of one way in which this conversion factor (CF_{σ}_{_{U}}) may be calculated:

$${CF}_{{σ}_{U}} = max ( 1 , \sqrt{\frac{{LT}_{d}}{{T}_{1}}} ) \qquad ( 3 )$$

where

LT_{d}=Total lead time in days

Ti=Time increment used for calculating the standard deviation of usage (default is 30)

The inventory processing module 1019 will then calculate the average of usage conversion factor. This conversion factor is used to estimate the value of the average use of a part over its lead time given an average that was computed using some other length of time. For example, this conversion factor can be used to estimate the average in a data set that had 90-day bins given calculated results with a 30-day bin. A minimum floor is set for this value of 1 to prevent under calculating the average use. Equation (4) provides an example of one way in which this conversion factor (CF_{x̅}_{_{U}}) may be calculated:

$${CF}_{{\overline{x}}_{U}} = max ( 1 , \frac{{LT}_{d}}{{T}_{1}} ) \qquad ( 4 )$$

where
LT_{d}=Total lead time in days
Ti=Time increment used for calculating the standard deviation of usage (default is 30)

The inventory processing module 1019 will then calculate a safety stock equation (stage 10012). A safety stock is computed in order to buffer the inventory level for a part and is intended to accommodate for fluctuations in the consumption of a part. In one embodiment the safety stock equation is determined by multiplying the standard deviation of usage (Equation 2) with the standard deviation conversion factor (Equation 3) to estimate the variance of the part usage observed during a part's lead time. The Z-score is factored into the equation to estimate the stock required to cover a desired probability of future demand. Equation (5) provides an example of one way in which the safety stock (Sft. Stk.) may be calculated:

$$\begin{matrix}Sft . Stk . = ⌈ Z * {CF}_{{σ}_{U}} * {σ}_{U} ⌉ \\ Where \\ Z = Z score ( service level ) ( default is 2 ) & ( 5 ) \\ {C F}_{{σ}_{U}} = max ( 1 , \sqrt{\frac{{LT}_{d}}{{T}_{1}}} ) & ( equation 3 ) \\ {σ}_{U} = \sqrt{\frac{{Σ ( x - {\overline{x}}_{U} )}^{2}}{n}} & ( equation 2 )\end{matrix}$$

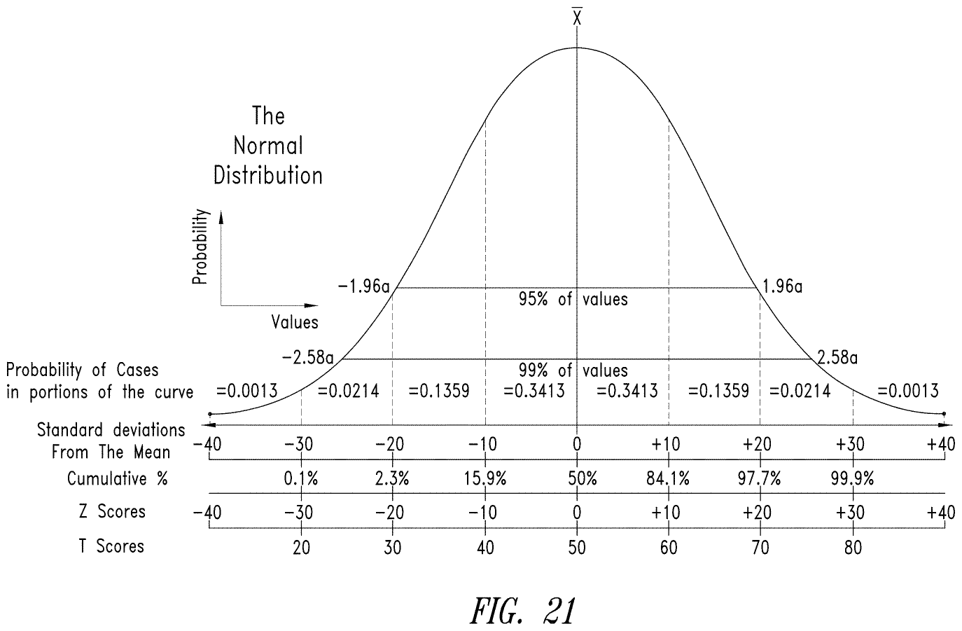

The Z-score is the number of standard deviations from the mean data point as illustrated in FIG. 21.

The inventory processing module 1019 then calculates the minimum and maximum inventory for the location (stage 10016). These are the limits of the quantity of parts to keep in the supply chain (on hand and on order) based on the usage over the part's lead time. This equation can be calculated for any period of time, thus the average usage for the applicable lead time period will be required. The safety stock is added to this result to account for the expected variation over the lead time. Equations (6) and (7) respectively provide examples of ways in which the minimum and maximum required inventories may be calculated:

$$\begin{matrix}{I}_{M i n} = ⌈ ( {CF}_{{\overline{x}}_{U}} * {\overline{x}}_{U} ) + Sft . Stk . ⌉ & ( 6 ) \\ {I}_{M ax} = ⌈ ( ( {CF}_{{\overline{x}}_{U}} + 1 ) * {\overline{x}}_{U} ) + Sft . Stk . ⌉ \\ where & ( 7 ) \\ {C F}_{{\overline{x}}_{U}} = max ( 1 , \frac{{LT}_{d}}{{T}_{1}} ) & ( equation 4 ) \\ {\overline{x}}_{U} = ⌈ \frac{Σ x}{n} ⌉ & ( equation 1 ) \\ Sft . Stk . = ⌈ Z * {CF}_{{σ}_{U}} * {σ}_{U} ⌉ & ( equation 5 )\end{matrix}$$

Using this evaluation method, new inventory minimum and maximum levels are calculated based on the calculations made at every transaction being recorded. Each time a minimum level is calculated, it is compared with the current quantity at the location. If the current quantity at the location is greater than the minimum inventory (stage 10020), the platform 1002 will not take any action (stage 10024). If the current quantity is less than the minimum inventory calculation, the inventory processing module 1019 will flag the warehouse location as needing inventory replenishment and initiate an evaluation of the inventory at other warehouse locations potentially holding inventory of the relevant part (stage 10028)

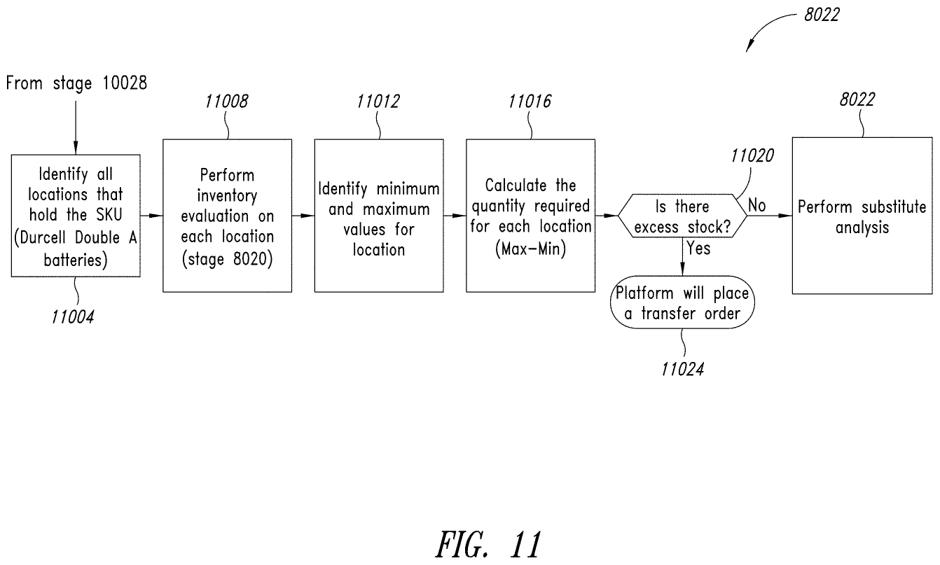

Referring again to FIG. 8, the process of performing an evaluation of inventory to assess need for inventory replenishment (stage 8012) further involves evaluating inventory at other warehouse locations for a part or item determined to require inventory replenishment at a warehouse location previously evaluated (stage 8022). An exemplary process performed by the inventory processing module 1019 for evaluating inventory at other warehouse locations pursuant to stage 8022 is illustrated in FIG. 11.

Currently, when an employee has found that a location within a warehouse has reached its fixed inventory target, they will be required to calculate how much inventory is required to replenish to the maximum level. Usually, the minimum and maximum levels have been pre-determined on a quarterly/monthly/weekly basis. These calculations allow the employee to place purchase orders for the location.

Turning now to FIG. 11, an exemplary process for evaluating inventory at other warehouse locations (stage 8022) is illustrated with respect to a case in which a warehouse location under evaluation (stage 8012) stores items in the form of Double A (AA) batteries. In particular, such warehouse location is assumed to store a particular SKU; namely, Duracell Brand Double A batteries. When the inventory processing module 1019 determines that a location needs inventory replenishment (stage 8020), the module 1019 will identify all other locations within the warehouse with the same part number for the double A batteries (stage 11004) and repeats the evaluation performed during stage 8020 at each warehouse location to the extent required to determine the current quantity of the part in the warehouse.

Once the inventory processing module 1019 has identified additional warehouse locations with the same part number, the module 1019 calculates the minimum and maximum inventory values for each such location (stage 11012) and the quantity required, if any, at each location in order to maintain the minimum inventory value at such location (stage 11016). The module 1019 then determines if the is a need to place an order for the part by evaluation whether there is any excess stock at any of the additional warehouse locations (stage 11020). In one embodiment this evaluation includes analyzing the historical consumption of each location as well as performing a more in-depth evaluation that identifies the time remaining to completely consume the stock in each identified location as well as whether there is any other excess stock of Double A batteries at the company site 1013 that can be used to refill the location under evaluation (stage 8012). For example, if other locations at the company site 1013 hold inventory levels over a pre-determined threshold, the module 1019 will recommend relocating stock from location to location in order to improve efficiency at the site 1013 (stage 11024). Additionally, if the module 1019 identifies that excess stock exists in storage, it will determine that the location can be restocked using the excess and will not require an order to be placed. In the event it is determined that no excess stock exists at the additional warehouse locations or at other locations within the customer site 1013, an analysis to identify substitute parts or items within the warehouse is performed (stage 8024).

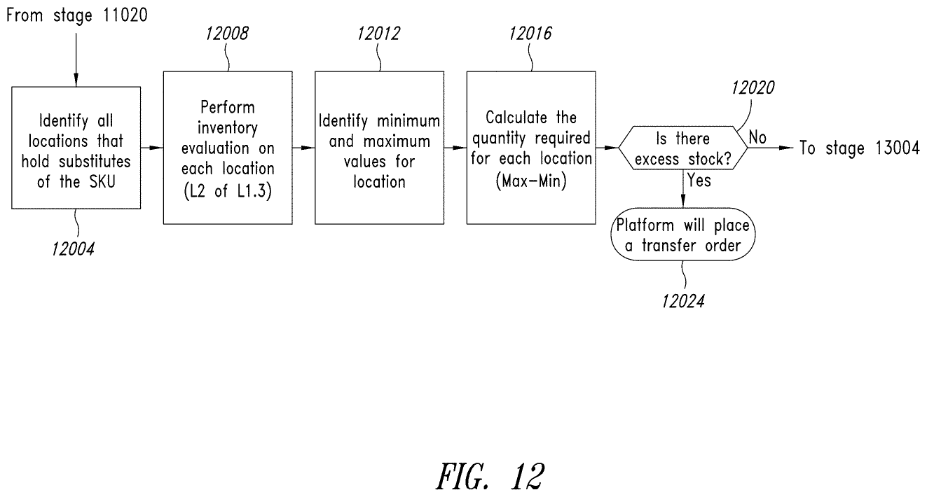

Referring to FIG. 12, there is illustrated an exemplary process for identifying item substitutes at locations within a warehouse containing a warehouse location under evaluation (stage 8024). In the event the inventory processing module 1019 determines that a need remains to add stock of an item to the warehouse location under evaluation after completion of stage 8022, the module 1019 will identify any substitute product that is currently being stocked elsewhere in the warehouse. In the present example, substitutes are defined as any brand of double A batteries other than the Duracell brand (e.g., Eveready or Energizer). Once the locations with substitute products have been identified by the inventory processing module 1019 and their respective quantities calculated (stage 12004), the module 1019 performs the evaluation of stage 8020 at each warehouse location to determine the current quantity of substitute items in each location (stage 12008). Next, the module 1019 will determine if there is a need to place an order for substitute items (e.g., Double A batteries other than of the Duracell brand) to replenish inventory at the warehouse locations holding the substitute items under evaluation. Specifically, the module 1019 calculates the minimum and maximum inventory values for each such location (stage 12012) and the quantity of Double A batteries required, if any, at each location in order to maintain the minimum inventory value at such location (stage 12016). The module 1019 then determines if there is a need to place an order for the part by evaluation whether there is any excess stock of the substitute items at any of the additional warehouse locations (stage 12020). In one embodiment this evaluation includes analyzing the historical consumption of the substitute items at each location as well as performing a more in-depth evaluation that identifies the time remaining to completely consume the stock of substitute items in each identified location as well as whether there is any other excess stock of substitute items at the customer site 1013. For example, if other locations at the company site 1013 hold inventory levels over a pre-determined threshold, the module 1019 will recommend relocating stock from location to location in order to improve efficiency at the site1013 (stage 12024). Additionally, if the module 1019 identifies that excess stock of the required substitute item exists in storage, it will determine that the location can be restocked using the excess and will not require an order to be placed.

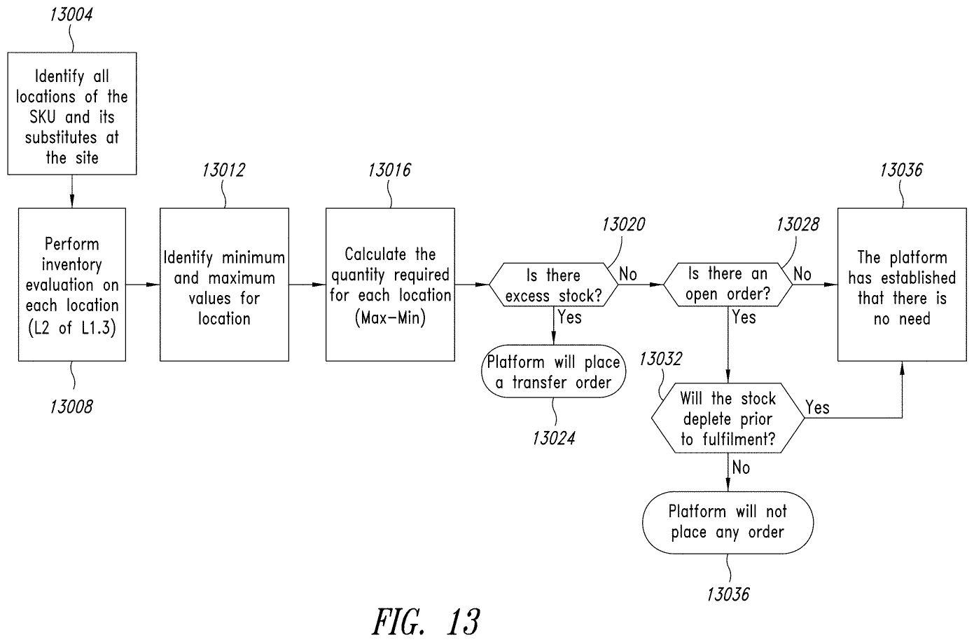

Turning now to FIG. 13, an exemplary process is shown for evaluating the availability of additional stock of the item at warehouse location under evaluation within other warehouses on the company site 1013 (stage 8028). The process illustrated in FIG. 13 is performed when the inventory processing module 1019 determines that a need remains to add stock of such item to such warehouse location after completion of stage 8024. In one embodiment the module 1019 will, pursuant to stage 8028, perform the evaluations associated with stages 8020, 8022, 8024 for all other warehouses 1011 in the customer site 1013. Specifically, the module 1019 will select a next warehouse 1011 in the customer site 1013 and identify all locations that hold the initially identified item or part number that triggered the need, as well as warehouse locations holding substitute part numbers (stage 13004). The module 1019 will perform the inventory evaluation of each location identified in order to calculate the current quantity of each identified location (stage 13008). Specifically, the module 1019 calculates the minimum and maximum inventory values for each such location (stage 13012) and the quantity of the item (e.g., Double A batteries) required, if any, at each location in order to maintain the minimum inventory value at such location (stage 13016).

Once the module 1019 has identified additional warehouse locations with any substitute and calculated their current need, it will identify if there is a need to place the order. The module 1019 will perform a more in-depth evaluation that identifies the time remaining to completely consume the stock in each identified location as well as whether the company is currently holding any excess stock of the item of interest (e.g., Double A batteries) that can be used to refill the warehouse location (stage 13020). If other locations at the customer site 1013 hold inventory levels over a threshold the module 1019 will create transfer orders and relocate stock from location to location in order to improve efficiency at the site (stage 13024). Additionally, if the module 1019 identifies that excess stock exists in storage, it will determine that the location can be restocked using the excess and will not require an order to be placed.

In one embodiment the inventory processing module 1019 scans existing orders to determine if any open orders for the SKU exist and will account for any orders that were placed in advance (stage 13028). If there are orders that were placed, the module 1019 will determine the time it will take for the current stock to deplete. If the time taken for the current stock to deplete is more than the time for any open orders to be fulfilled (stage 13032), the module 1019 will not generate an instruction causing an order for the SKU to be placed by the platform 1002 (stage 13036). However, if the time taken is less than any open orders, the module 1019 will determine that an order should be placed. In this way the platform 1002 will determine the total quantify of the SKU required for the customer site 1013 and will commit to placing an order with a vendor 1008 for at least this total quantity. As is discussed below, under certain conditions an order for more than the total quantity of the SKU required for the company site 1013 may be placed.

As may be appreciated from the preceding discussion, the inventory processing module 1019 is configured to determine whether a need exists for additional inventory of the item of interest (stage 8034) based upon the results of evaluations occurring during the inventory evaluation of stage 8012 (i.e., based on the results of stages 8020, 8022, 8024 and 8028). If the module determines that there is no need for additional inventory of such item following the completion of stage 8012, then no further evaluation is carried out and inventory processing is concluded (stage 8038). If, on the other hand, the inventory processing module 1019 determines that an order for additional inventory of the item of interest must be placed (stage 8034), in one embodiment the platform 1002 will attempt to obtain the best possible price for the customer 1004 by gaining price savings when purchasing a larger quantity of the item of interest.

Referring again to FIG. 8, in one embodiment the platform 1002 evaluates the potential for purchasing such a larger quantity of the item of interest by identifying other customers 1004 that have the requirement for the same item (stage 8038). In order to service other customers, the services of a local delivery firm 1012, or “box breaker”, will be required, which will add a cost to the overall purchase. As a first step in so identifying such other customers, the platform 1002 will identify box breakers 1012 that service the original customer 1004 that triggered the initial need for the item of interest as well as other customers 1004 that are eligible for local delivery (stage 8042)

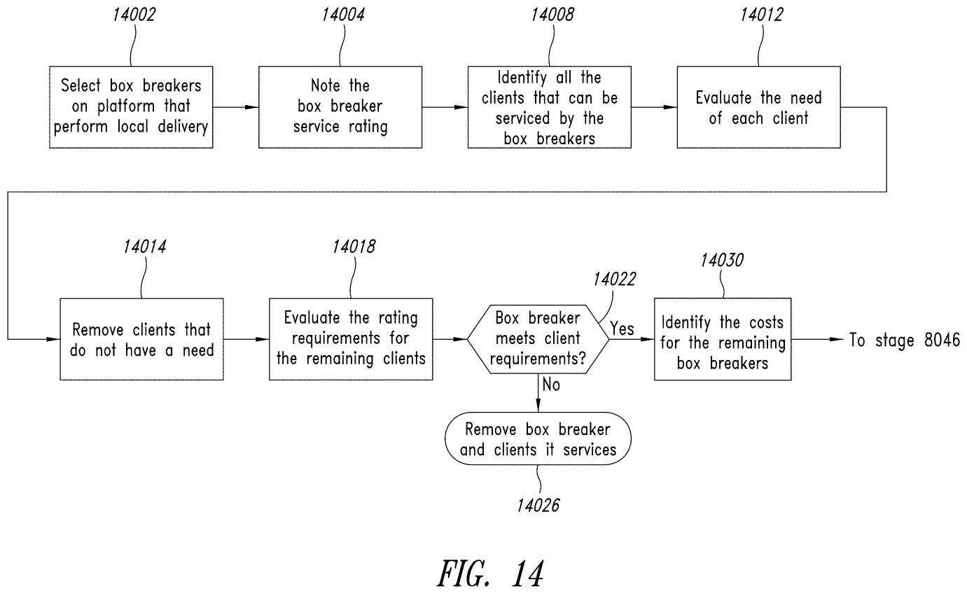

FIG. 14 illustrates an exemplary process for identifying other customers having a requirement for an item of interest that are also capable of being serviced by local delivery (stage 8042) . In one implementation local delivery is defined as delivery that can be fulfilled within one day of receiving the product. Upon identifying the box breakers 1012 (stage 14002), the platform 1002 will also factor in the cost of the box breaker. Additionally, the platform 1002 may also note the service rating of the selected box breakers 1012 (stage 14004) and match them against the requirements of the customers that can be serviced. This will allow the platform 1002 to filter box breaker selections against the customer requirements (stage 14008).

Once box breakers 1012 have been selected, the platform 1002 will search for all the customers 1004 that each box breaker 1012 can deliver to under local delivery. When the platform 1002 has identified all such customers 1004, it will calculate whether those customers 1004 have a need for the item of interest, e.g., Double A batteries (stage 140012). To this end the inventory processing module 1019 will perform the evaluation that was completed in stages 8020, 8022, 8024, 8028. Specifically, in one embodiment the inventory processing module 1019 evaluates each customer 1004 individually by identifying the locations that hold the product in all warehouses across the company site 1013 and evaluating the current need for replenishment in accordance with stages 8020, 8022. The platform 1002 will then evaluate all the substitute products across all warehouses in the manner discussed above with reference to stages 8024, 8028 in order to assess the total quantity requirement for the item of interest. If this evaluation determines that the customer 1004 requires that a purchase be made, the platform 1002 will add the customer 1004 to a matrix of purchasers (or maintain the customer 1004 within such a matrix). If the evaluation indicates that such customer 1004 does not require a purchase, the customer 1004 is not added to the matrix (or is removed from the matrix if present by default) (stage 14014).

For customers 1004 requiring a purchase, the platform 1002 evaluates their respective rating requirements (stage 14018). Box breakers 1012 determined to not meet such customer requirements (stage 14022) are removed from consideration as well as the customers 1004 serviced by the removed box breakers 1012 (stage 14026). For box breakers 1012 meeting client requirements (stage 14022), the associated costs for such remaining box breakers 1012 are identified (stage 14030).

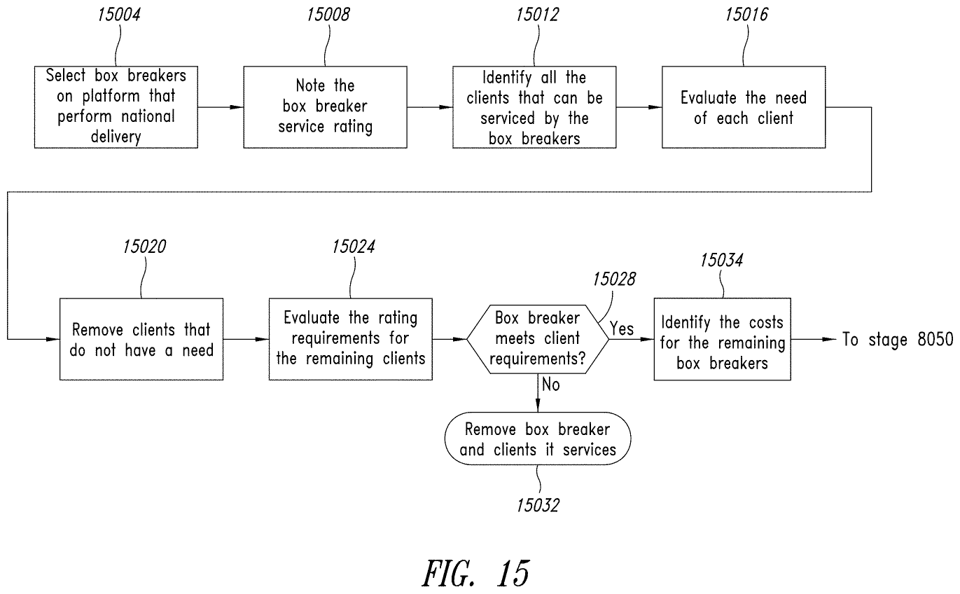

Referring again to FIG. 8, once all customers 1004 that can be serviced by local delivery have been identified, the scope for delivery will be increased to non-local over the road delivery, which may be referred to herein as national delivery (stage 8046). FIG. 15 illustrates an exemplary manner in which additional customers potentially requiring the item of interest are evaluated for national delivery pursuant to stage 8046.

Turning now to FIG. 15, the platform 1002 will identify box breakers 1012 that service the original customer 1004 that triggered the initial need for the item of interest as well as other customers 1004 across the nation (stage 15004). In this stage 15004, box breakers 1012 will be connected to other box breakers 1012 across the nation in order to complete deliveries to customers 1004. To begin the selection of box breakers 1012, in one embodiment the platform 1002 will first identify a master box breaker 1012 that will receive the initial shipment. This can perform local delivery to companies closest to it and then deliver the remaining product to other box breakers 1012 that will further deliver it to customers. This process will add logistics costs to the overall price, and customers 1004 that are in close proximity to the applicable vendor 1008 will receive the products at a cheaper as opposed to customers 1004 that require multiple box breakers 1012 to complete the delivery. Additionally, the platform 1004 will note the service rating of the selected box breakers 1012 and match them against the requirements of the clients that can be serviced (stage 15008). This will allow the system to filter box breaker selections against the customer requirements.

Once box breakers 1012 have been selected, the platform 1002 will search for all the customers 1004 that the box breaker 1012 can deliver to under local delivery (stage 15012). When the platform 1002 has identified all the customers 1004, it will calculate whether those customers 1004 have a need for the item of interest, e.g., Double A batteries (stage 15016). In one embodiment the platform 1002 executes stage 15016 by performing the evaluation that was completed in stages 8020, 8022, 8024, 8028. Each customer 1004 will be evaluated individually as the platform 1004 will identify the locations that hold the item of interest in all warehouses 1011 across the customer site 1013 and will evaluate their current need as previously describe above with respect to stages 8020, 8022. The platform 1002 will then also evaluate all the substitute products across all warehouses in the manner discussed above with respect to stages 8024, 8028 in order to assess the total quantity of the item of interest required. If this evaluation determines that the customer 1004 requires that a purchase be made, the platform 1002 will add the customer 1004 to a matrix of purchasers (or maintain the customer 1004 within such a matrix). If the evaluation indicates that such customer 1004 does not require a purchase, the customer 1004 is not added to the matrix (or is removed from the matrix if present by default) (stage 15020).

For customers 1004 requiring a purchase, the platform 1002 evaluates their respective rating requirements (stage 15024). Box breakers 1012 determined to not meet such customer requirements (stage 15028) are removed from consideration as well as the customers 1004 serviced by the removed box breakers 1012 (stage 15032). For box breakers 1012 meeting client requirements (stage 15028), the associated costs for such remaining box breakers 1012 are identified (stage 15034).

Again referring to FIG. 8, once the platform 1002 has completed the identification of customers 1004 that can be serviced based on the box breaker delivery area (stages 8042, 8046), in one embodiment the analytics engine 1020 will perform a predictive calculation that aims to ascertain a speculative need for each customer 1004 that was identified for the selected box breaker 1012 during stages 8042, 8046 (stage 8050). In one implementation the set of customers 1004 evaluated for speculative need for the item of interest includes customers 1004 that do not have a current need for the item of interest and were previously removed from the evaluation matrix. This predictive calculation is performed to determine whether or not a speculative purchase of the item of interest would yield a greater savings for the customers 1004 having a current need for the item of interest than would simply purchasing sufficient inventory of the item of interest to fulfill the current demand.

In one embodiment the predictive calculation for speculative need will continue forward from the calculation formulated in the previous stages (i.e., stages 8042, 8046) by evaluating (e.g., using machine learning techniques) the historical trend for the locations at the company site 1013 and determining the average consumption over a 1-month, 3-month and 6-month time frames. This will allow the platform 1002 to calculate the quantity usage over those time frames and predict the quantity usage for the future 1-month, 3-month and 6-month time frames. By using this calculation, the platform 1002 will determine the speculative need for the customer 1004. In addition to calculating the speculative need, the platform 1002 will calculate the storage costs for each time frame calculated. The platform 1002 will identify different storage companies near the customer 1004 that can house the excess stock and the cost for each over the time frame. The platform 1002 will then run this against the risk factor for each speculative purchase. As may be appreciated, as the time frame increases the risk factor also increases.

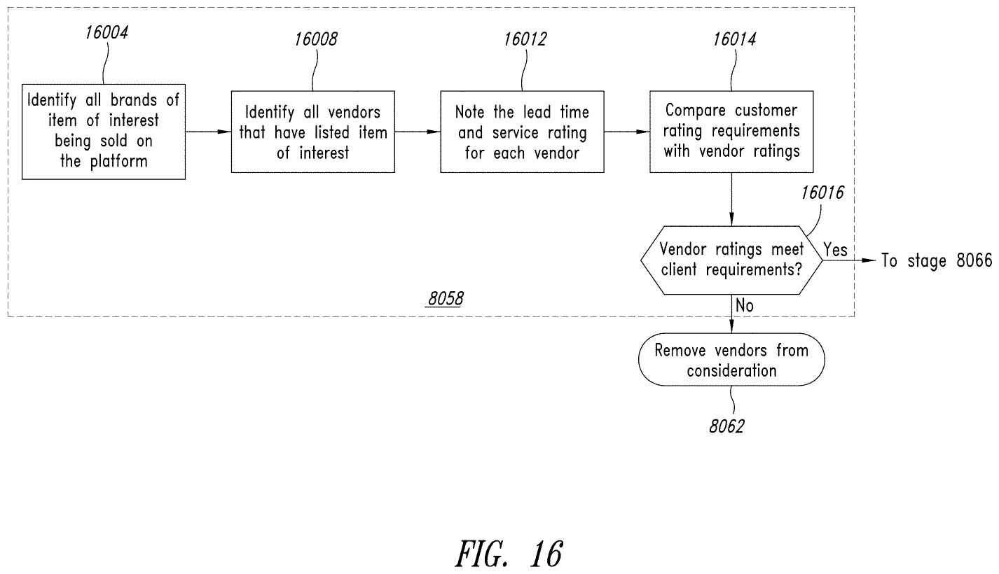

As shown in FIG. 8, once a speculative need for the item of interest among other customers 1004 has been calculated, the platform 1002 identifies available brands of the item of interest and selects vendors 1008 capable of providing the identified brands (stage 8054). FIG. 16 illustrates an exemplary manner in which available brands of the item of interest may be identified and vendors 1008 selected pursuant to stage 8054.

Currently, in order to find perform a thorough evaluation of what products are available in the market, employees are required to browse multiple company websites and their catalogs to determine whether or not such companies sell an item of interest (e.g., Double A batteries). This process would typically include attempting to find companies that sell the brand that is currently stocked at the location as well as viable substitutes that could instead be used. This process is extremely tedious and time consuming for the employee performing the task.

Turning now to FIG. 16, the platform 1002 is configured to identify product alternatives available for sale (stage 8058) as part of an efficient process of identifying available brands of the item of interest and selecting vendors 1008 pursuant to stage 8054. In one implementation the process of identifying product alternatives available for sale performed by the platform 1002 includes identifying all the product alternatives that can be purchased to fulfill the need established pursuant to stage 8038. The platform 1002 will generally by configured to create a matrix of all the product alternatives that are currently at each identified customer site 1013 and run that list through the products available from vendors 1008 1008 via the platform 1002 and will create a matrix of the available brands of the item of interest (stage 16004). The platform 1002 will then select vendors 1008 1008 that provide the item of interest (e.g., double A batteries) and add them to the comparison matrix (stage 16008). As each vendor 1008 is identified, a rating and lead time for that vendor 1008 is also noted on the comparison matrix to show the popularity/performance of the vendor 1008 (stage 16012). This trait may be used in subsequent stages to identify an optimal vendor 1008.

Presently, employees tasked with selecting from which suppliers to purchase products generally must scan through multiple websites and review boards in order to gauge the reputation of suppliers/vendors 1008. Employees typically must read through each review that is available to them and make a selection based on the information they have gathered. This task alone is one of the most tedious aspects of the assessment required to select products.

In contrast, the platform is configured to scan through the overall review (star based/ranking based metrics that are used by customers on the platform) for each vendor 1008 collected in stage 16008 and compare them to the required ranking level preferences of each customer 1004 that is on the list (stage 16014). Vendors 1008 that do not meet the recorded rating requirements submitted by customers 1004 (stage 16016) will be removed (stage 8062). The platform 1002 will perform individual evaluations for the ratings by starting with the customer 1004 that originally triggered the need for the item of interest. For example, if such customers have specified a minimum rating requirement of “3 stars”, the platform 1002 will eliminate all vendors 1008 that are rated below the 3-star rating level (stage 8062). This process of determining whether vendor ratings meet customer requirements (stages 16014, 16016) is then repeated for each customer 1004. Based on the outcome of the comparison performed during stages 16014, 16016 for each customer 1004, vendors 1008 not meeting the applicable rating requirements will continue to be removed from the list of eligible vendors 1008. The platform 1002 will maintain the highest rating requirement to fulfill the order.

Once the platform 1002 has identified vendors 1008 that provide the item of interest and its substitute brands, the platform 1002 will perform a search for all different types of packages the vendors 1008 have listed on the platform 1002 and compile each packaging permutation in a matrix representation according to their SKU (stage 8066). Along with each SKU, the platform 1002 will also record the performance rating of that SKU to show quality/performance of the product. (stage 8068). In one implementation this data will be used in a forthcoming stage to select the vendor 1008 best suited to provide the product. This process will list every type of packaging variation that is currently available on the platform 1002 and the resulting data will be used to identify the best possible purchase that can be made. This process may be completed nearly instantaneously, as opposed to the manual processes currently being implemented.

Once the platform 1002 has identified all the SKU's available on the platform, it will begin to create permutations of product SKUs from vendors 1008 capable of fulfilling demand for area being serviced (stage 8070). In one implementation permutations are created for an area being serviced corresponding to one customer, local delivery to more than one customer, and national delivery to multiple customers.

The total products being ordered will be evaluated against all possible SKUs in order to calculate the various options that could be selected. These permutations will allow the platform 1002 to perform a price comparison, as is discussed further below.

Once a final list of eligible vendors 1008 has been determined as discussed above, the platform 1002 will initiate a lead time calculation for each location of interest by calculating the average usage of the product in that location by using the average usage equation (stage 8072). The average usage equation yields the average consumption of the product during a set time period (e.g., 1 week). The average consumption of the product during the set time period will be compared to the current quantity at the location. The platform 1002 will calculate the time it will take the current quantity to be exhausted (i.e., reach 0 inventory) by dividing the average consumption during the set time period (e.g., 1 week) by the current quantity and multiply the result by 7. This will indicate the lead time that the supplier must meet before the location is empty. The platform 1002 will repeat this step for every location that is being taken into consideration under the site, the area and the region.

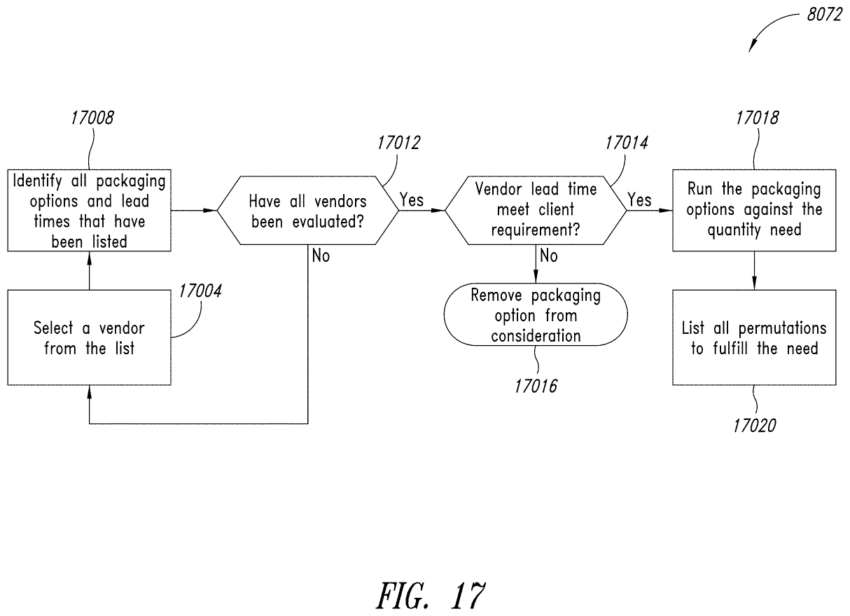

FIG. 17 illustrates additional details of an exemplary process for calculating vendor lead times pursuant to stage 8072. The platform initially selects a vendor 1008 to be evaluated (stage 17004). For the selected vendor, all packaging options and lead times that have been listed are identified (stage 17008). This process continues until all available vendors 1008 have been evaluated (stage 17012). Once this has occurred, it is determined whether the vendor lead times for each packaging option meet client requirements (stage 17014). Any such packaging options are removed from further consideration (stage 17016). The platform 1002 then evaluates the remaining packaging options against the quantity needed (stage 17018) and lists all permutations fulfilling the need (stage 17020).

In one implementation the platform 1002 will, pursuant to stage 17008, update SKU matrices for the location quantity to show the vendor lead times. This step may also be repeated for each substitute product previously identified with respect to the item of interest. The platform 1002 will obtain the lead times provided by the vendors 1008 for when they are able to fulfill the given quantity for each SKU available. The platform 1002 may also update a matrix of each of the substitute SKU matrices for the location quantity to show the vendor lead times.

Referring to FIG. 8, once lead times required to prevent inventory exhaustion at each customer location are calculated pursuant to stage 8072, a pricing evaluation is performed (stage 8074). In particular, a priced per unit cost of each permutation is calculated and the lowest price option is selected. In contrast, warehouse employees currently need to manually calculate the product costs for each SKU that is available in the market. This conventional process includes gathering the prices for each SKU from vendor websites and multiplying with the number of units that are needed to be purchased. This exercise is required to be performed for all vendors 1008 and their available SKUs, which is tedious and costly.

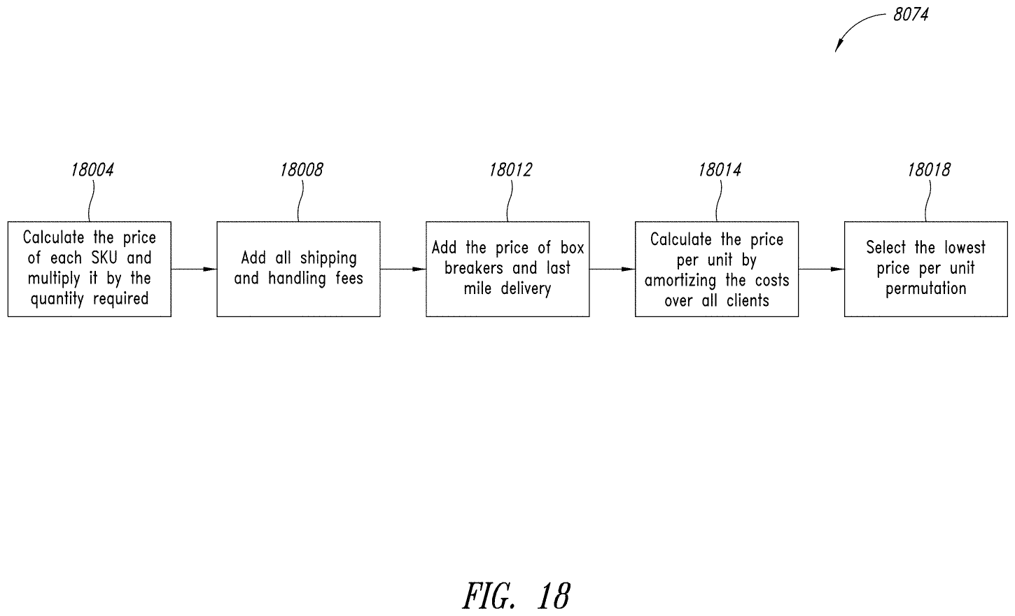

FIG. 18 illustrates further details of an exemplary process for pricing evaluation pursuant to stage 8074. After identifying each SKU available on the platform 1002 in stage 8066, a calculation of the number of units needed to fulfill the quantity required was also made. To calculate the price for the SKUs of the item of interest (e.g., Double A batteries) for the initial warehouse location, the number of units of the SKU required to fulfill the quantity required are multiplied by the price of one unit of the SKU (stage 18004). Shipping and handling fees are added to the calculation so as to accurately represent the total cost of the quantity required (stage 18008). The calculations of stages 18004 and 18008 will be performed for each substitute item previously identified as corresponding to the item of interest as well as the different SKUs and their units.

Next, the price of box breakers 1012 and last mile delivery for the required quantity is added to the total cost (stage 18012). A price per unit is then calculated by amortizing the costs over all customers 1004 (stage 18014) and the permutation having the lowest price per unit is selected (stage 18018). In one embodiment the platform 1002 will not permit orders for partial packs of products to be made. In this case the smallest available package will be required and is accounted for. The customer 1004 will need to explicitly state on their customer/company profile whether they prefer their locations to be overstocked (i.e., greater than the estimated maximum quantity) or understocked (i.e., less than the maximum quantity). This will help the platform 1002 determine the best package sizes to select in order to attain the closest value to the maximum quantity for the location.

Referring again to FIG. 8, in one embodiment the platform 1002 will perform a selection process that will narrow down which product and quantity to purchase to fulfill the need for the item of interest (stage 8075). This selection process will involve the evaluation of the prices and costs of each permutation for the given product quantities. The total costs have been amortized over all customers into a per unit cost (stage 8074). This per unit cost will be compared across all vendors 1008 and will be used as the deciding factor.

It may be appreciated that the vendors 1008 that do not meet the applicable customer requirements have already been eliminated from consideration prior to stage 8075. In one embodiment the vendor 1008 that offers the lowest total price (product quantity, shipping and handling, box breaking and last mile delivery) within the remaining vendors 1008 will be selected by the platform 1002. Each product permutation that has been identified will be evaluated on an individual basis. If multiple vendors 1008 offer the same or nearly the same price (i.e., the best price) for a given product permutation, the platform 1002 will typically be configured to select the vendor 1008 that has the better reputation, i.e., higher rating.

Finally, the platform 1002 will run another comparison to determine whether there is a significant savings for the customer if the an order were to be placed for the original location or a whether a significant savings is made when ordering for customers that qualify for local delivery or the customers that qualify for national delivery. In some embodiment and in view of the different permutations being calculated at this stage, the platform 1002 may use multiple options instead of just one sole vendor 1008 and amortize the price for each customer that it is servicing.

Once the final selection(s) of vendor(s) and product permutation(s) has been completed pursuant to stage 8075, the selected customers 1004 having orders required to be fulfilled will be given a list of options for additional services (stage 8076). The additional services may involve selecting other vendors 1008 to complete key activities such as box breaking or stocking. In one implementation all service providers within proximity to the customer 1004 that are registered on the platform 1002 will be presented. After being electronically provided with a list of optional services (stage 19004), the customer 1004 may respond by choosing from any of the listed optional services. If the customer 1004 decides to choose one or more service (stage 19008), such optional services are added to the order for such customer 1004 and only such customer 1004 is billed for the selected service costs; that is, the selected service costs are separated from the other costs of item fulfillment (stage 19010). This will ensure that no optional services are amortized for in the price of the product and will be billed directly to the customer that requests it. If the customer 1004 does not request optional services, the customer is billed only for the quantity of the items of interest required (stage 19012).

The platform 1002 will generally provide the customer 1004 with a breakup of each line item that the customer 1004 will need to pay individually based on the services selected and the quantity they require in order to fulfill their need. In some cases, the optional services will be rendered free if they are included in the services provided by the service providers employed by an operator of the platform 1002 to fulfill the order.

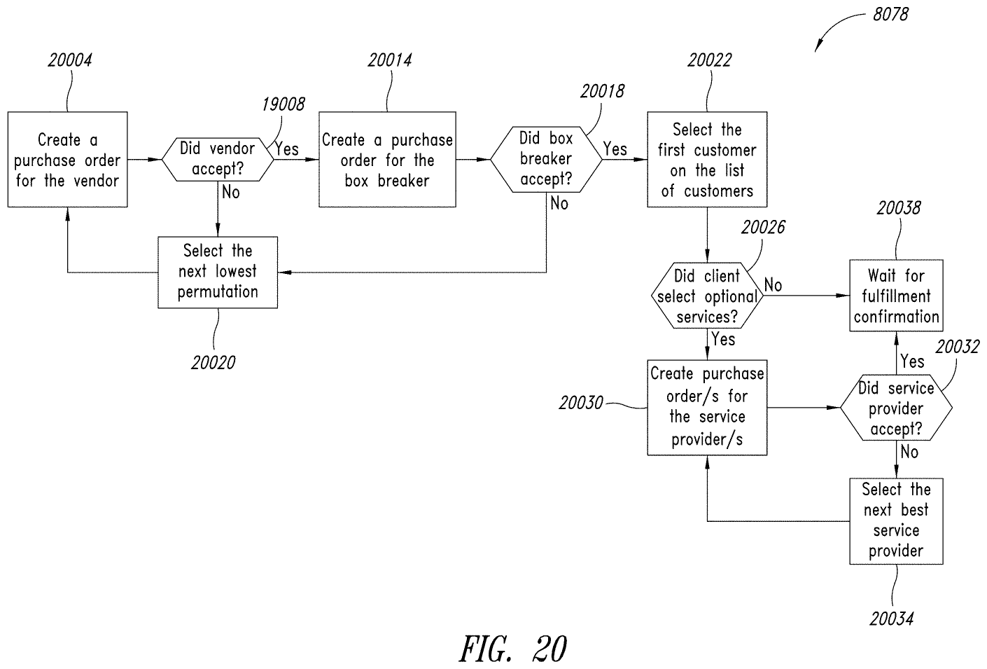

Again referring to FIG. 8, the platform 1002 is operative to create and send purchase orders to selected vendors 1008 once the customer 1004 has completed the optional services request discussed above (stage 8078). Since the platform 1002 has identified the vendor 1008 from the which the products corresponding to the item of interest will purchased, following the completion of stage 8075 the platform 1002 proceeds to create a purchase order for such vendor 1008 and for any other vendors 1008 of optional services selected by the customer 1004. FIG. 20 illustrates an exemplary process carried out by the platform 1002 in connection with creating and sending such purchase orders to selected vendors 1008.

Referring to FIG. 20, the platform 1002 creates a purchase order for issuance to the preferred vendor 1008 for the products corresponding to the item of interest that are being purchased (stage 20004). The platform 1002 will provide the preferred vendor 1008 with the applicable delivery address (address of box breaker 1012 or of the original customer 1004). In one embodiment the platform 1002 is configured to preserve all alternate pathways of product acquisition from vendors 1008 in the event that the preferred vendor 1008 does not respond to a purchase order sent to them. If the preferred vendor 1008 does not so respond to an issued purchase order (stage 20008), the platform selects the next lowest-priced product permutation (stage 20020) and initiates the process of creating and sending a purchase order to an alternate vendor.

If the preferred or alternate vendor 1008 accepts the purchase order sent to it (stage 20008) and the platform 1002 has selected a box breaker 1012 to service an area, the platform 1002 will issue a purchase order for the box breaking service and provide the selected box breaker 1012 with customer addresses as well the quantities that need to be delivered (stage 20014). If the selected box breaker 1012 does not respond to the purchase order sent to it (stage 20018), the platform 1002 selects the next lowest-priced permutation (stage 20020) and initiates the process of creating and sending a purchase order to an alternate box breaker.

Next, an initial customer 1004 is selected from the list of customers for which the selected product permutation(s) corresponding to the item of interest will be purchased (stage 20022). If the initial customer 1004 selects any optional services (stage 20026), the platform 1002 creates a purchase order for the selected service provider and provide them with the necessary information (stage 20030). If either the initial customer 1004 did not select any optional services (stage 20026) or instead selected optional services for which the selected service provider accepted a purchase order (stage 20032), the platform 1002 waits for fulfillment confirmation (stage 20038).

In one embodiment the platform 1002 is configured to preserve all alternate pathways of providing optional services in the event that the preferred vendor 1008 does not respond to a purchase order sent to them. Accordingly, in the event a service provider does not respond to a purchase order for optional services (stage 20032), the platform 1002 will select the next best option (e.g., next lowest-priced service provider) in order to complete the purchase transaction (stage 20034). In one embodiment this approach is applied to each vendor 1008 that is being selected in the predictive model disclosed herein (i.e., supplier, box breaker, last mile delivery, put away).

Turning again to FIG. 8, once the platform 1002 has received confirmation of product delivery and completion of services from all vendor(s) involved (stage 8080), the platform 1002 will issue respective payments to each vendor 1008 and/or service provider involved in the product fulfillment life cycle (stage 8082) and adjust and record updated inventory levels at the applicable warehouse location(s) (stage 8008). Effectively, the platform 1002 will function to track every product fulfillment pathway to completion. In one embodiment completion will be deemed to occur when a vendor 1008 or service provider 1012 has indicated to the platform 1002 that they have completed their role in delivering to a customer 1004. For example, if an order is placed to a vendor 1008 for a particular product (e.g., Double A batteries of brand “A”), the vendor 1008 will need to complete delivery to, for example, a box breaker 1012 and indicate to the platform 1002 that such delivery has been completed. The box breaker 1012 will confirm receipt of the delivery on the platform 1002 and will proceed to deliver the product to the customer 1004. The box breaker 1012 in some cases will also stock the product for the customer 1004 at specific locations. When the product has been so stocked to the specified locations, the platform 1002 will be updated with new product quantities and this will act as confirmation that the product has reached the customer 1004.

Alternatively, a vendor 1008 delivering the product to the customers 1004 or to a box breaker 1012, as applicable, will not be issued payment by the platform 1002 until the recipient customers 1004/box breaker 1012 has confirmed that they have received the shipment. Similarly, in one implementation if a box breaker 1012 is delivering the product to the customers, the box breaker 1012 will be issued their payment by the platform 1002 when the platform 1002 has detected (e.g., received appropriate sensor or scanning signals) indicating that new product has been stocked at the locations of interest. For any optional services that were selected and paid for by the customer 1004, in one implementation the platform 1002 will issue payment to the service provider 1012 when the service provider 1012 has reported that the service was performed. For orders relating to speculative needs, the platform 1002 will release payment to the vendor 1008 when the products have reached the appropriate storage facility.

In one embodiment the operator of the platform 1002 requires customers 1004 to place the value of their order into an escrow account upon placing the order. This escrow amount would then be used by the platform operator to complete payments to the vendors 1008 when their tasks have been fulfilled.

It may be appreciated that in certain embodiments the platform 1002 need not perform all of the operations illustrated with reference to FIGS. 8-21. For example, and with reference to FIG. 8, in some embodiments the platform 1002 may not be configured to, once an inventory replenishment need has been determined in stage 8012, proceed to identify other customers in the defined area having a need for the item of interest pursuant to stage 8038. Rather, the platform 1002 could instead proceed to stage 8054 after completing stage 8012. Similarly, in other embodiments the platform may not be configured to identify product alternatives and/or remove vendors not satisfying client requirements in stage 8054; that is, processing could proceed from stage 8038 (or even stage 8012) to stage 8066. In addition, in some embodiments may not be configured to perform each of the sub-stages described with reference to FIG. 8. For example, in some embodiments substitute items within a given warehouse may be identified pursuant to stage 8024 when performing stage 8012. Nor will quality/performance for packaging configurations necessarily recorded in all implementations of stage 8066, or optional services offered pursuant to 8076. In this respect FIGS. 8-21 should be viewed as representing an array of possible actions that could be performed by the platform 1002 as part of the disclosed inventory evaluation and replenishment process rather than as a rigid prescription of required operations.

In some configurations, the apparatus or system includes means for performing various functions as described herein. In one aspect, the aforementioned means may be a module including a processor or processors and associated memory in which embodiments of the invention reside, such as are shown in the preceding drawings and which are configured to perform the functions recited by the aforementioned means. This may be, for example, modules or apparatus residing in client devices, host server systems, and/or other network devices such as are shown and/or described herein. In another aspect, the aforementioned means may be a module or apparatus configured to perform the functions recited by the aforementioned means.

In one or more exemplary embodiments, the functions, methods and processes described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

As used herein, computer program products comprising computer-readable media including all forms of computer-readable medium except, to the extent that such media is deemed to be non-statutory, transitory propagating signals.

It is understood that the specific order or hierarchy of steps or stages in the processes and methods disclosed are examples of exemplary approaches. Based upon design preferences, it is understood that the specific order or hierarchy of steps in the processes may be rearranged while remaining within the scope of the present disclosure.

The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps or stages of a method, process or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. This includes all types of puzzle games where players are given a fixed number of moves to complete the goals.

The disclosure is not intended to be limited to the aspects shown herein, but is to be accorded the full scope consistent with the specification and drawings, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members.

As an example, “at least one of: a, b, or c” is intended to cover: a; b; c; a and b; a and c; b and c; and a, b, and c.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the principles and novel features disclosed herein.

What is claimed is:

1. A computer-implemented system for analyzing and replenishing inventories of items used by a plurality of manufacturer customers operating at a plurality of customer sites, the items being supplied by a plurality of vendors, the system comprising:
a network interface for communicating, over one or more networks, with servers associated with the plurality of vendors and with electronic inventory tracking devices deployed within customer warehouses at the plurality of customer sites wherein at least a subset of the electronic tracking devices are implemented by one or more of: electronic shelf labels, handheld electronic devices, smart drawers, coil devices, smart cabinets and scanner systems;
a database containing inventory levels of the items;
a memory for storing instructions; and
one or more processors configured to execute the instructions for:
receiving, from the electronic inventory tracking devices, indications of inventory changes in the inventory levels of the items at warehouse locations within customer warehouses at the plurality of customer sites;
updating the inventory levels of the items within the database based upon the indications of inventory changes;
evaluating, in response to the indications of inventory changes, the inventory levels of the items at the warehouse locations to determine whether inventories of the items are required to be replenished wherein the instructions for evaluating include instructions for:
calculating safety stocks of the items at the warehouse locations so as to accommodate for fluctuations in usage of the items at the warehouse locations, calculating, based upon the safety stocks, minimum inventory levels for the items at the warehouse locations, comparing current inventory levels of the items at the warehouse locations to respective ones of the minimum inventory levels,
evaluating, for depleted warehouse locations at which the current inventory level for an item is less than the minimum inventory level for the item, other of the current inventory levels of the item at a first set of warehouse locations included in the warehouse locations,
identifying, for the depleted warehouse locations, any substitute items for the item at a second set of warehouse locations included in the warehouse locations;
performing a dredictive speculative need calculation to determine, for ones of the manufacturer customers utilizing other warehouse locations at which the current inventory level for the item exceeds the minimum inventory level for the item, whether speculative purchases of the item for speculative warehouse locations included among the other warehouse locations would yield savings for the ones of the manufacturer customers;
determining, based upon results of the instructions for comparing, the instructions for evaluating, the instructions for identifying, and the instructions for performing a predictive speculative need calculation that an aggregate need exists to place an order to replenish stock of the item at the depleted warehouse locations and at one or more of the other warehouse locations;
identifying one or more item alternatives to the item that can be purchased to fulfill the aggregate need;
selecting a set of the vendors capable of providing the item and the one or more item alternatives;
compiling packaging type information relating to different packaged quantities of the item and the one or more item alternatives that can be purchased from the set of vendors;
generating, based upon the packaging type information, purchase permutations of purchases of the item and the one or more item alternatives from the set of vendors that could be made to fulfill the aggregate need;
calculating overall prices for the purchase permutations wherein each overall price is determined based upon a number of units required within a corresponding vendor service area and per unit prices for the item and the one or more item alternatives associated with ones of the set of vendors;
selecting, based upon the overall prices for the permutations, ones of the purchase permutations in order to fulfill the aggregate need; and
generating purchase orders for the selected purchase permutations on behalf of the customer manufacturers associated with the depleted warehouse locations and the speculative warehouse locations, the purchase orders being for quantities of the item and the item alternatives.

2. The system of claim 1 wherein the instructions for evaluating the inventory levels further include instructions for calculating average usages and standard deviation of usages of the items at the warehouse locations and wherein the instructions for calculating safety stocks of the items at the warehouse locations are based upon respective ones of the average usages and standard deviation of usages.

3. The system of claim 1 wherein the first set of warehouse locations and the second set of warehouse locations are included within ones of the customer warehouses located at a first customer site of the plurality of customer sites, the instructions further including instructions for:
identifying a second customer site having one or more additional warehouses having warehouse locations requiring replenishment of the item,
including an amount of stock of the item required to be replenished at the second customer within the aggregate need for the item.

4. The system of claim 1 wherein each of the purchase permutations corresponds to an area being serviced and wherein a first of the areas being serviced corresponds to a first customer site of the plurality of customer sites.

5. A computer-implemented system for analyzing and replenishing inventories of items used by a plurality of manufacturer customers operating at a plurality of customer sites, the items being supplied by a plurality of vendors, the system comprising:
a network interface for communicating, over one or more networks, with servers associated with the plurality of vendors and with electronic inventory tracking devices deployed within customer warehouses at the plurality of customer sites wherein at least a subset of the electronic tracking devices are implemented by one or more of: electronic shelf labels, handheld electronic devices, smart drawers, coil devices, smart cabinets and scanner systems;
a database containing inventory levels of the items;
a memory for storing instructions; and
one or more processors configured to execute the instructions for:
receiving, from the electronic inventory tracking devices, indications of inventory changes in the inventory levels of the items at warehouse locations within customer warehouses;
updating the inventory levels of the items within the database based upon the indications of inventory changes;
evaluating, in response to the indications of inventory changes, the inventory levels of the items at the locations to determine whether inventories of the items are required to be replenished wherein the instructions for evaluating include instructions for evaluating a first change in a first inventory level of a first item at a first warehouse location at a first customer site, the instructions for evaluating the first change in the first inventory level including instructions for:
calculating a first average usage and a first standard deviation of usage of the first item,
calculating a first safety stock of the first item so as to accommodate for fluctuations in usage of the first item, the instructions for calculating the first safety stock including instructions for estimating a first variance in usage of the first item based upon the first standard deviation of usage,
calculating, based upon the first average usage and the first safety stock, first inventory minimum and maximum levels for the first item at the first warehouse location;
comparing a first current inventory level of the first item at the first warehouse location to the first inventory minimum level for the first item,
evaluating other inventories of the first item at other warehouse locations at the first customer site,
identifying any substitute items for the first item at other warehouse locations at the first customer site,
determining, based upon results of the instructions for comparing, the instructions for evaluating and the instructions for identifying, that a need exists to place an order to replenish stock of the first item at the first warehouse location;
identifying a second customer site requiring replenishment of the first item, wherein a first amount of stock of the first item required to be replenished at the first warehouse location and a second amount of stock of the first item required to be replenished at the second customer site comprise an aggregate need for the first item;
identifying one or more item alternatives to the first item that can be purchased to fulfill the aggregate need;
selecting a set of the vendors capable of providing the one first item and the one or more item alternatives;
compiling packaging type information relating to different packaged quantities of the first item and the one or more item alternatives that can be purchased from the set of vendors;
generating, based upon the packaging type information, purchase permutations of purchases of the first item and the one or more item alternatives from the set of vendors that could be made to fulfill the aggregate need wherein each of the purchase permutations corresponds to an area being serviced and wherein a first of the areas being serviced corresponds to the first customer site;
calculating overall prices for the purchase permutations wherein each overall price is determined based upon a number of units required within a corresponding one of the areas being serviced and per unit prices for the first item and the one or more item alternatives associated with ones of the set of vendors;
selecting, based upon the overall prices for the permutations, one or more of the purchase permutations in order to fulfill the aggregate need; and
generating one or more purchase orders for the one or more selected purchase permutations on behalf of the customer manufacturers associated with the depleted warehouse locations, the purchase orders being for quantities of at least one of the item and the item alternatives.

6. The system of claim 5 wherein the instructions for evaluating other inventories of the first item at other warehouse locations at the first customer site include instructions for:
identifying one or more other warehouses at the first company site containing the first item, the other warehouse locations being located within the one or more other warehouses, evaluating a second change in a second inventory level of the first item at a second warehouse location at a second warehouse wherein the second warehouse is included among the one of more other warehouses at the first customer site.

7. The system of claim 6 wherein the instructions for evaluating the second change in the second inventory level further includes instructions for:
calculating a second average usage and a second standard deviation of usage of the first item at the second warehouse location,
calculating a second safety stock of the first item so as to accommodate for fluctuations in usage of the first item at the second warehouse location, the instructions for calculating the second safety stock including instructions for estimating a second variance of the usage of the first item at the second warehouse location based upon the second standard deviation of usage,
calculating, based upon the second average usage and the second safety stock, second inventory minimum and maximum levels for the first item at the second warehouse location;
comparing a second current inventory level of the first item at the second warehouse location to the second inventory minimum level for the first item.

8. The system of claim 7 wherein the instructions for evaluating the second change in the second inventory level further include instructions for:
identifying any substitute items for the first item at the second warehouse, determining one of: (i) that a need exists to place an order to replenish stock of the first item at the first second warehouse location, and (ii) that the second warehouse location holds excess stock of the first item.

9. The system of claim 5 wherein the instructions for identifying the second customer site requiring replenishment of the first item further includes instructions for evaluating a second change in a second inventory level of the first item at a second warehouse location at the second customer site.

10. The system of claim 9 wherein the instructions for evaluating the second change in the second inventory level further includes instructions for:
calculating a second average usage and a second standard deviation of usage of the first item at the second warehouse location,
calculating a second safety stock of the first item so as to accommodate for fluctuations in usage of the first item at the second warehouse location, the instructions for calculating the second safety stock including instructions for estimating a second variance of the usage of the first item at the second warehouse location based upon the second standard deviation of usage,
calculating, based upon the second average usage and the second safety stock, second inventory minimum and maximum levels for the first item at the second warehouse location;
comparing a second current inventory level of the first item at the second warehouse location to the second inventory minimum level for the first item.

11. The system of claim 10 wherein the instructions for evaluating the second change in the second inventory level include instructions for:
evaluating other inventories of the first item at other warehouse locations at the second customer site,
identifying any substitute items for the first item at other warehouse locations at the second customer site,
determining, based upon results of the instructions for comparing, the instructions for evaluating and the instructions for identifying performed with respect to the second warehouse location and the second customer site, that a need exists to place an order to replenish stock of the first item at the first second warehouse location.

12. The system of claim 5 wherein the instructions for calculating a first average usage (x̅_{U}) of the first item include instructions for calculating:
$${\overline{x}}_{U} = ⌈ \frac{Σ x}{n} ⌉$$
where
x=number of units of the first item used in one time period bin,
Σx=sum of number of units of the first item used in an averaging period,
n=number of time period bins in the averaging period.

13. The system of claim 12 wherein the instructions for calculating the first standard deviation of usage (σ_{U}) of the first item include instructions for calculating:
$${σ}_{U} = \sqrt{\frac{{Σ ( x - {\overline{x}}_{U} )}^{2}}{n}}$$

14. The system of claim 5 wherein the instructions for identifying a second customer site requiring replenishment of the first item include instructions for:
identifying local delivery service entities servicing the customer site;
identifying other customer sites serviced by the local delivery service entity;
determining that one or more of the other customer sites have a need for stock of the first item, the second customer site being included among the one or more other customer sites.

15. The system of claim 14 wherein the instructions for determining that one or more of the other customer sites have a need for stock of the first item includes instructions for:
determining warehouse locations at the second customer site that hold the first item;
evaluating, for each of the warehouse locations at the second customer site that hold the first item, inventory levels of the first item, the instruction for evaluating at each of the warehouse locations including instructions for:
calculating a second average usage and a second standard deviation of usage of the first item,
calculating a second safety stock of the first item at least in part by estimating a second variance in usage of the first item based upon the second standard deviation of usage,
calculating, based upon the second average usage and the second safety stock, second inventory minimum and maximum levels for the first item;
comparing a second current inventory level of the first item to the first inventory minimum level for the first item,
evaluating other inventories of the first item at other warehouse locations at the second customer site,
identifying any substitute items for the first item at other warehouse locations at the second customer site,
determining, based upon results of the instructions for comparing, the instructions for evaluating and the instructions for identifying performed with respect to the warehouse location at the second customer site being evaluated, that a need exists to place an order to replenish stock of the first item at the warehouse location at the second customer site being evaluated.

16. The system of claim 5 wherein the instructions for selecting the one or more of the purchase permutations include instructions for one of: (i) automatically selecting the one or more of the purchase permutations associated with the lowest of the overall prices, and (ii) selecting the one or more of the purchase permutations in response to user input.

17. The system of claim 1 wherein the electronic inventory tracking devices include a plurality of electronic shelf labels wherein at least a portion of the electronic shelf labels each include a user interface displaying an item inventory level, a user-selectable take switch and a user-selectable return switch.

18. A computer-implemented system for analyzing and replenishing inventories of items used by a plurality of manufacturer customers operating at a plurality of customer sites, the items being supplied by a plurality of vendors, the system comprising:
a network interface for communicating, over one or more networks, with servers associated with the plurality of vendors and with electronic inventory tracking devices deployed at locations at the plurality of customer sites;
a database containing inventory levels of the items;
a memory for storing instructions; and
one or more processors configured to execute the instructions for:
receiving, from the electronic inventory tracking devices, indications of inventory changes in the inventory levels of the items at the locations within the plurality of customer sites;
updating the inventory levels of the items within the database based upon the indications of inventory changes;
evaluating, in response to the indications of inventory changes, the inventory levels of the items at the locations to determine whether inventories of the items are required to be replenished wherein the instructions for evaluating include instructions for:
comparing current inventory levels of the items at the locations to respective ones of minimum inventory levels,
identifying, for depleted locations at which the current inventory level for an item is less than the minimum inventory level for the item, any substitute items for the item at other locations,
determining, based upon results of the instructions for comparing and the instructions for identifying, that an aggregate need exists to place an order to replenish stock of the item at the depleted locations;
selecting a set of the vendors capable of providing the item;
compiling packaging type information relating to different packaged quantities of the item;
generating, based upon the packaging type information, purchase permutations of purchases of the item from the set of vendors that could be made to fulfill the aggregate need;
calculating overall prices for the purchase permutations wherein each overall price is determined based upon a number of units;
selecting, based upon the overall prices for the permutations, ones of the purchase permutations in order to fulfill the aggregate need; and
generating purchase orders for the selected purchase permutations on behalf of the customer manufacturers associated with the depleted locations.

19. A computer-implemented system for analyzing and replenishing inventories of items used by a plurality of manufacturer customers operating at a plurality of customer sites, the items being supplied by a plurality of vendors, the system comprising:
a network interface for communicating, over one or more networks, with servers associated with the plurality of vendors and with electronic inventory tracking devices deployed at locations at the plurality of customer sites;
a database containing inventory levels of the items;
a memory for storing instructions; and
one or more processors configured to execute the instructions for:
receiving, from the electronic inventory tracking devices, indications of inventory changes in the inventory levels of the items at the locations within the plurality of customer sites;
updating the inventory levels of the items within the database based upon the indications of inventory changes;
evaluating, in response to the indications of inventory changes, the inventory levels of the items at the locations and determining that an aggregate need exists to place an order to replenish stock of the item at ones of the locations;
performing a predictive speculative need calculation to determine, for other ones of locations at which current inventory levels for the item exceed minimum inventory levels for the item, whether speculative purchases of the item would yield savings wherein the performing the predictive speculative need calculation includes evaluating historical trend data using machine learning techniques to predict item usage for multiple different periods and calculating associated item storage costs for the multiple different time periods;
generating purchase permutations of purchases of the item from a set of that plurality of vendors that could be made to fulfill the aggregate need and a speculative need predicted by the performing the predictive speculative need calculation;
selecting ones of the purchase permutations in order to fulfill the aggregate need and the speculative need; and
generating purchase orders for the selected purchase permutations.
